(19) United States
(12) Patent Application Publication
(10) Pub. No.: US 2013/0198082 A1
(43) Pub. Date: Aug. 1, 2013

(54) PAYMENT SERVICE THAT PROVIDES OPTION TO AUTHENTICATE WITH EXTERNAL AUTHENTICATION SERVICE

(71) Applicant: Paymintz, Inc., Manhattan Beach, CA (US)

(72) Inventor: Todd Michael Eichner, Manhattan Beach, CA (US)

(73) Assignee: PAYMINTZ, INC., Manhattan Beach, CA (US)

(21) Appl. No.: 13/797,729

(22) Filed: Mar. 12, 2013

Related U.S. Application Data
(63) Continuation-in-part of application No. 13/281,254, filed on Oct. 25, 2011.

(51) Int. Cl. G06Q 20/38

(52) U.S. Cl. CPC G06Q 20/3821
USPC 705/44

(57) ABSTRACT

A system and associated methods are disclosed for enabling users to use third party account login information to make payments to merchants. A payment service receives a user's identifier in response to a user authentication request sent over a network to an authentication service of an information or credit service. The user authentication request includes login credentials of the user for the information service or credit and is associated with a payment page of a merchant that has an account with the payment service. The payment service receives the user identifier when the information or credit service validates the login credentials. Based at least in part on the user identifier, the payment service receives payment information from the information or credit service. The payment service provides the user with an option to use the retrieved payment information to make a payment to the merchant.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### BACKGROUND

1. Technical Field

This disclosure relates generally to computer-implemented services for enabling merchants and other entities to collect payments from users.

2. Description of the Related Art

Consumers today routinely shop and make purchases of products and services over the Internet using web browsers. Numerous Internet merchants have set up web sites allowing customers to browse through descriptions of products and services and pay bills. After the customer has selected one or more products for purchase or has selected the payment option, Internet merchants typically provide the customer with a checkout or payment page requesting payment information from the customer. The payment information usually comprises a credit card number, expiration date, cardholder name, and any other information that may be required to authorize a charge against the customer's card. If applicable, shipping information may also be requested on the checkout page.

It is often considered an inconvenience for a customer to have to enter in the often lengthy amount of information required to process a credit card transaction each time the customer makes a payment or purchase. In some instances, the inconvenience discourages the consumer from completing the transaction.

As a consequence, a number of merchants allow the consumer to select a user ID and a password when providing payment and/or delivery information. The merchant's system retains the customer's information and associates it with the user ID and password. In this manner the customer enters her user ID and password in order to make subsequent purchases from the respective merchant. Customers typically, however, make purchase from more than one merchant. Different merchants may have different formats for a user ID and a password. Furthermore, a customer's preferred user ID may already be in use by another customer at a particular merchant. Consequently, a customer will likely have to remember several user IDs and/or passwords. Again, the inconvenience of having to remember yet another user ID and password may discourage the consumer from completing the transaction.

### SUMMARY

According to certain embodiments, a method performed by a computer-implemented payment service to enable users to use authentication service account information to make payments to merchants is provided. The method comprises hosting a payment page of a merchant that has an account with the payment service, where the payment page provides functionality for users to make payments to the merchant, and the payment page comprises fields for user entry and submission of authentication service account log-in credentials. The method further comprises transmitting the payment page over a network to a user computing device in response to a request received from the user computing device, and receiving, from the user computing device, authentication service account log-in credentials of a user. The log-in credentials are submitted by the user via the payment page. The method further comprises sending a user authentication request over a network to an authentication service site, where the user authentication request comprises the log-in credentials of the user, and the authentication service is distinct from the payment service, and receiving a response from the authentication service to the user authentication request. The response includes a user identifier of the user. The user identifier is distinct from the log-in credentials of the user. The method further comprises sending a request for credit card information of the user over the network to a credit service, where the credit card information request comprises the user identifier, and receiving credit card information of the user from the credit service in response to the request for credit card information. The credit card information comprises at least a credit card number. The method further comprises retrieving consumer information of the user from a database of the payment service based at least partly on the user identifier received from the authentication service. The consumer information obtained by the payment service is based on a previous payment transaction conducted by the user. The consumer information excludes complete credit card numbers. The method further comprises providing an option for the user to use the retrieved consumer information and the received credit card number to make a payment to the merchant. The method is performed in its entirety by a computing system of the payment service.

In accordance with other embodiments, a method performed by a computer-implemented payment service to enable users to use authentication service account information to make payments to merchants is disclosed. The method comprises receiving a user identifier of a user in response to a user authentication request sent over a network to an authentication service. The user authentication request is associated with a payment page of a merchant that has an account with a payment service. The payment page provides functionality for users to make payments to the merchant and the payment page includes a user prompt for prompting the user to log into the authentication service and a link to at least one authentication service site. The user authentication request comprises authentication service log-in credentials of the user. The user identifier is received when the authentication service validates the authentication service log-in credentials. The method further comprises receiving credit card information of the user from an information service in response to a request for credit card information of the user, where the credit card information comprises at least a credit card number, and automatically retrieving consumer information of the user from a database of the payment service based at least partly on the user identifier received from the authentication service. The consumer information obtained by the payment service is based on a previous payment transaction conducted by the user. The consumer information excludes complete credit card numbers. The method further comprises providing an option for the user to use the retrieved consumer information and the received credit card number to make a payment to the merchant. The method is performed in its entirety by a computing system of the payment service.

In some embodiments, a payment service system of a payment service for enabling users to use authentication service account information to make payments to merchants is provided. The payment service system comprises a computer system comprising one or more computers. The computer system is programmed with executable code modules to at least receive a user identifier of a user in response to a user authentication request sent over a network to an authentication service. The user authentication request is associated with a payment page of a merchant that has an account with a payment service. The payment page provides functionality for users to make payments to the merchant. The payment page includes a user prompt for prompting the user to log into the authentication service and a link to at least one authentication service site. The user authentication request comprises authentication service log-in credentials of the user and the user identifier is received when said authentication service validates the authentication service log-in credentials. The computer system is programmed with further executable code modules to at least receive credit card information of the user from a credit reporting service in response to a request for credit card information of the user, where the credit card information comprises at least a credit card number, automatically retrieve consumer information of the user from a database of the payment service based at least partly on the user identifier received from the authentication service where the consumer information obtained by the payment service is based on a previous payment transaction conducted by the user, and where the consumer information excludes complete credit card numbers, and provide an option for the user to use the retrieved consumer information and the received credit card number to make a payment to the merchant.

Neither this summary nor the following detailed description purports to define or limit the scope of protection. The scope of protection is defined only by the claims.

### BRIEF DESCRIPTION OF THE DRAWINGS

Embodiments of invention will now be described with reference to the drawings summarized below. These drawings and the associated description are provided to illustrate specific embodiments of the invention, and not to limit the scope of the invention.

FIG. 1 illustrates the principal components of an embodiment of a system that permits users to make payments to merchants.

FIG. 2 illustrates a data flow diagram showing the transfer of information between the payment service server, the credit card fulfillment service server, the authentication service server, and the consumer computer for a first transaction, according to certain embodiments.

FIG. 3 illustrates an exemplary web page displayed to the consumer before authentication for the first transaction, according to certain embodiments.

FIG. 4 illustrates an exemplary web page displayed to the consumer after authentication for the first transaction, according to certain embodiments.

FIG. 5 illustrates a data flow diagram showing the transfer of information between the payment service server, the credit card fulfillment service server, the authentication service server, and the consumer computer for a second transaction, according to certain other embodiments.

FIG. 6 illustrates an exemplary web page displayed to the consumer before authentication for the second transaction, according to certain embodiments.

FIG. 7 illustrates an exemplary web page displayed to the consumer after authentication for the second transaction, according to certain embodiments.

FIG. 8 is a flow chart illustrating a process through which a consumer has the option of using retrieved payment information to make a payment to a merchant, according to certain embodiments.

FIG. 9 illustrates the principal components of another embodiment of a system that permits users to make payments to merchants.

FIG. 10 illustrates a data flow diagram showing the transfer of information between the payment service server, the information service server, the credit card fulfillment service server, the authentication service server, and the consumer computer for a first transaction, according to certain embodiments.

FIG. 11 illustrates an exemplary web page displayed to the consumer before authentication for the first transaction, according to other embodiments.

FIG. 12 illustrates an exemplary web page displayed to the consumer after authentication for the first transaction, according to other embodiments.

FIG. 13 illustrates a data flow diagram showing the transfer of information between the payment service server, the information service server, the credit card fulfillment service server, the authentication service server, and the consumer computer for a second transaction, according to other embodiments.

FIG. 14 illustrates an exemplary web page displayed to the consumer before authentication for the second transaction, according to other embodiments.

FIG. 15 illustrates an exemplary web page displayed to the consumer after authentication for the second transaction, according to other embodiments.

FIG. 16 is a flow chart illustrating a process through which a consumer has the option of using retrieved payment information to make a payment to a merchant, according to other embodiments.

### DETAILED DESCRIPTION OF SPECIFIC EMBODIMENTS

The present invention comprises a computer-implemented payment service that enables users to use social media account information (or, in some embodiments, account information with another type of external site or service or other authentication service) to make payments to merchants. The payment service advantageously enables users to make payments to merchants (and/or other types of entities) without establishing login accounts with such merchants, and without having to create a login account with the payment service. In some embodiments, the system that hosts the payment service also hosts merchant-specific payment pages that can be accessed by users to initiate payments to the merchant. The system may also host tools for enabling merchants to create and customize their respective payment pages.

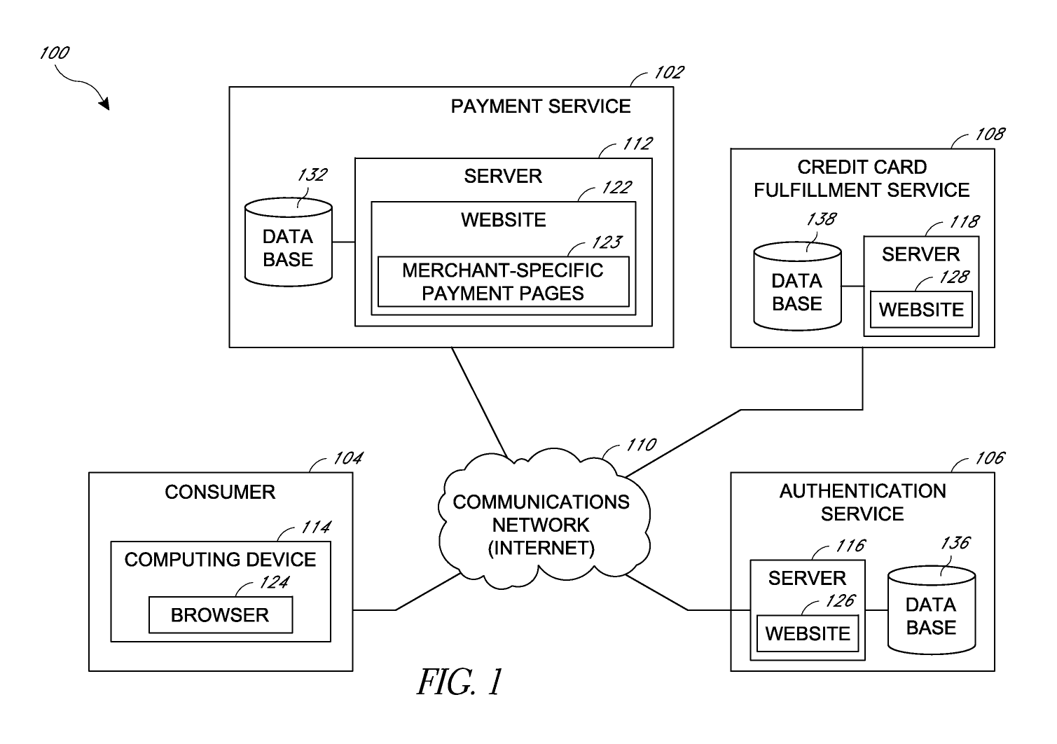

In a typical scenario, embodiments of which are described below with respect to FIGS. 1-8, the user browses to a payment page of a merchant having an account with the payment service. The payment page includes a prompt for prompting the user to log into one or more authentication services, such as social media sites, and links to the authentication service of the one or more social media sites. From there, the user selects the option to authorize the payment with the payment service using the user's login credentials for a particular social media service. The user selects a particular social media site from the social media site selections and enters his login credentials. The selected social media site receives the login credentials and authorizes the user. The authorization service of the social media site sends to the payment service via the user's computer a valid authorization message and a unique identifier associated with the user. The payment service receives over a network the valid authorization message and the unique user identifier from the authentication service. The payment service retrieves payment information of the user from its database based at least partly on the unique user identifier received from the authentication service. The payment information was obtained by the payment service based on a previous payment transaction conducted by the user. The payment service then provides the user with an option to use the retrieved payment information to make a payment to the merchant. In an embodiment, the payment service populates the payment page with the retrieved payment information. The user verifies the payment information and submits the populated payment page to the payment service.

For a more detailed understanding of one embodiment of the invention, reference is first made to FIG. 1. FIG. 1 illustrates the principal components of an embodiment of a transaction system 100 that permits users to make payments to merchants. A consumer 104 can be any individual or other entity that wishes to make purchases of products or services from a merchant. In order to select and purchase products or services or make other payments, the customer preferably uses a web or mobile browser 124 running on a computing device 114. The computing device 114 can be any device that allows the consumer 104 to interact with the system 100, such as, for example, a conventional computer and modem, an interactive wireless communications device, a laptop, an iPAD, an iPhone, a smartphone, a personal digital assistant, an interactive television, a game console, or the like.

The merchant is an entity that collects payments from consumers 104. In some cases, the merchant may sell products to the consumers 104 and use the payment service to collect payments from the consumers 104. In other cases, the merchants may include service providers (e.g., fitness centers, tutoring services, etc.) that use the payment service to collect payments from the consumers 104. In other examples, the merchants may include charitable organizations that use the payment service to accept donations from consumers 104. The payments can be for a one-time transaction for the purchase of a particular good or service, or the payments can be recurring transactions, such as monthly electric company payments, monthly fitness center charges, and the like.

In order to process transactions, merchants typically require consumer information. Consumer information may include, for example, the consumer's name, the consumer's address, shipping address(es), email address, payment information, such as, for example, a credit card number, expiration date, and billing address, and the like. Typically, merchants accept credit card payments from authenticated users or consumers to increase the likelihood that the consumer information is trustworthy and decrease the likelihood of fraud. In addition to providing consumer information, the consumer 104 is often asked to provide authentication information, such as, for example, a user identification (user ID) and password. If the consumer 104 has not previously set up an account with the merchant, then the consumer 104 is further burdened with the task of setting up an account with the merchant in order to be associated with the authentication information. In some instances, the consumer 104 decides to abort the purchase rather than spend time entering consumer information, authentication information, and account information. To avoid losing sales, the merchant uses a payment service 102 to provide the authenticated consumer information to the consumer 104. The consumer 104 easily verifies the provided consumer information and verifies the payment amount or enters the payment amount before submitting the purchase.

The payment service 102 is a computer-implemented service that hosts merchant-specific payment pages 123 of registered merchants. Through these payment pages 123, consumers 104 can make online payments to the corresponding merchants using authenticated consumer information provided by the payment service 102. In one embodiment, the payment service 102 enables merchants to sell items online or to otherwise collect payments without the need to create or operate a web site.

In other embodiments, the merchant may host the payment page on a web site that it operates. In yet further embodiments, a third-party may host the payment pages.

The payment service 102 can interface with merchants and consumers 104 through a payment service web site 122 hosted by a server 112. (Each server shown in FIG. 1, including the payment service server 112, may include one or more computing devices, such as one or more physical servers.) In the embodiment illustrated in FIG. 1, the payment service web site 122 includes the merchant-specific payment pages 123. In an embodiment, the payment service 102 assigns to each payment page 123 a unique uniform resource locator (URL), such as, for example, www.payservice.com/merchantA, www.merchantA.payservice.com, or the like. The payment service server 112 accesses a payment service database 132, which stores consumer information.

The merchant is associated with the payment service 102 by, for example, subscribing to the payment service 102, having an account with the payment service 102, and the like. Individual merchants, upon enrolling online with the payment service 102, can set up one or more customized payment pages 123. These payment pages 123 can include descriptions of specific products, services, or other items that are available to consumers 104. In other cases, a merchant can set up a payment page 123 than enables consumers 104 to pay their monthly or other bills. As described above, the payment service 102 can assign to each payment page 123 a unique uniform resource locator (URL). Merchants can send out the URL for one or more payment pages 123 to their customers 104 to allow the customers to use the payment page for payments to the merchant. In other cases, the merchants can provide a link from their web sites to the payment page 123. Merchants, upon enrolling, can either enter their preexisting merchant bank account information, request that the payment service 102 set up a merchant bank account to receive the payments, use a third party master merchant account, use an Internet Payment Service Provider (ISPS) account, or the like.

To avoid having consumers 104 provide authentication information that is specific to a particular merchant, the payment service 102 prompts consumers 104 to log into an external authentication service 106 using their existing authentication information for the particular authentication service. Although a single authentication service 106 is shown, the payment service 102 may interact with multiple distinct authentication services 106 associated with multiple distinct services or sites. In an embodiment, the authentication service 106 is part of a social media service or social networking service, such as, for example, Facebook, twitter, OpenID, Google+, MySpace, Bebo, Friendster, hi5, Orkut, PerfSpot, Zorpia, Netlog, Habbo, and the like. In another embodiment, the authentication service 106 is part of a webmail service, such as for example, Gmail, AOL mail, Yahoo! Mail, Hotmail, Blue Tie, Zoho Mail, AIM Mail, Mail.com, Gawab.com, FastMail, and the like. The authentication service 106 is accessible through a web site 126, which is implemented using a server 116. The authentication service server 116 accesses an authentication service database 136, which stores authentication information for the particular authentication service. The authentication service server 116 sends to the payment service server 112 via the computing device 114 and the browser 124 a unique identifier associated with the consumer 104 when the authentication service 106 authenticates the consumer 104.

The payment service server 112 retrieves payment information associated with the unique identifier from the payment service database 132 and provides the payment information to the computing device 114 through the browser 124. The consumer 104 reviews the provided consumer information and, optionally, submits the information to make a payment to the merchant. The payment service 102 serves the payment information to a credit card fulfillment service 108.

The credit card fulfillment service 108 is preferably an entity that specializes in account processing for payments made via credit card from a credit card fulfillment web site 128, which is implemented using a server 118. The server 118 accesses fulfillment information via a fulfillment database 138. The credit card fulfillment service 108 receives the payment information, charges the consumer's credit card, and credits the merchant's account.

In the context of the present disclosure, actions indicated as being taken by the payment service 102 are preferably performed by or through, as applicable, the payment service server 112 and its associated software components. Actions indicated as being taken by the consumer 104 are preferably performed by or through, as applicable, the web or mobile browser 124 and/or the computing device 114. Actions indicated as being taken by the authentication service 106 are preferably performed by or through, as applicable, the authentication service server 116 and its associated software components. Actions indicated as being taken by the credit card fulfillment service 108 are preferably performed by or through, as applicable, the authentication service server 118 and its associated software components.

Each of the functional components shown in FIG. 1 may be implemented in program code executed by one or more general or special purpose computers. The databases 132, 136, and 138 can comprise one or more logical and/or physical data storage systems for storing data and applications used by the servers 112, 116, and 118, respectively.

The payment service server 112, the computing device 114, the authentication service server 116, and the credit card fulfillment service server 118 connect to a communications network 110, which preferably is or includes the Internet.

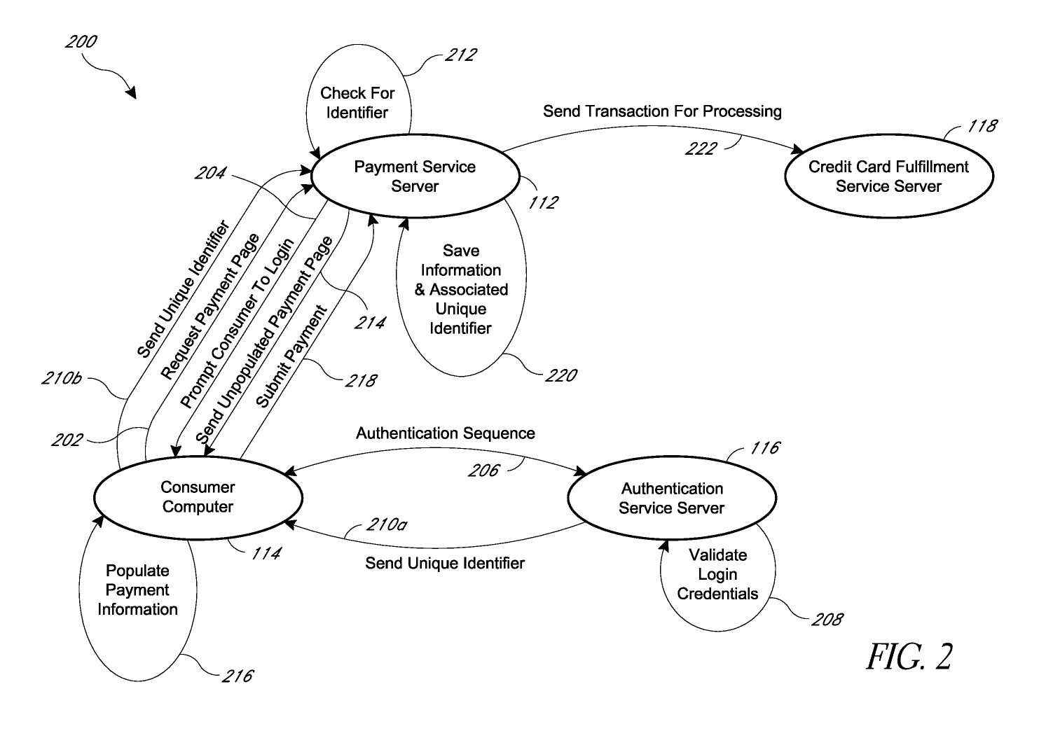

FIG. 2 illustrates an exemplary data flow diagram 200 showing the transfer of information between the payment service server 112, the consumer computer 114, the authentication service server 116, and the credit card fulfillment service server 118 for a first transaction. The first transaction is the first time the consumer 104 is making a payment through the payment service 102.

In a typical use case scenario, a consumer 104 initially accesses a merchant-specific payment page (not shown) that corresponds to a particular item that is available from the corresponding merchant. More specifically, in event 202 of FIG. 2, the consumer 104, through the browser 124 and the computing device 114 requests a payment page associated with the merchant.

In an embodiment, the payment service 102 hosts the payment page and the payment service server 112 serves the payment page to the consumer computer 114, as indicated by event 204. In another embodiment, the merchant hosts the payment page and the merchant server serves the payment page to the consumer computer 114. In yet another embodiment, a third-party entity hosts the payment page and a server of the third-party serves the payment page to the consumer computer 114.

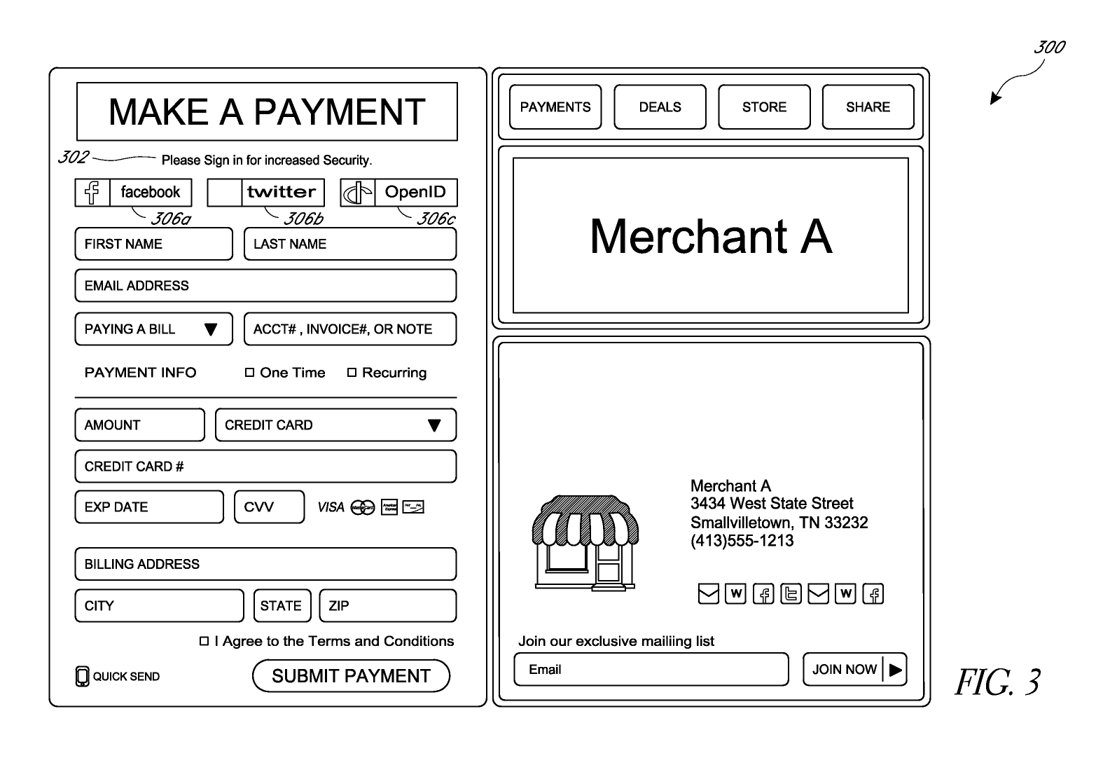

FIG. 3 illustrates an exemplary payment page 300 displayed to the consumer 104 before authentication of the first transaction. In the illustrated embodiment, Merchant A, a hypothetical merchant, serves as the Internet merchant. The payment page 300 prompts the consumer 104 to log into an external authentication site, as indicated by event 204. In the illustrated example, a prompt 302 “Please sign in for increased security” prompts the consumer 104 to select an external authentication service 106, such as a social networking service, a social media service, or a webmail service. In the illustrated example, the consumer 104 selects from one of the social networking sites, Facebook 306a, twitter 306b, and OpenID 306c.

Referring to FIG. 2, at event 206, the consumer 104 selects one of the presented external authentication services 106. The external authentication service server 116 receives the login request and the external authentication service server 116 serves the consumer computer 114 with a login page or other object through an application programming interface of the external authentication service 106. The consumer 104 enters the login information or login credentials, such as, for example, a user ID and a password, associated with the consumer 104 for the selected external authentication service 106. The external authentication service 106 validates the login credentials according to the procedure in place at the selected external authentication service 106.

In one embodiment, for example, the authentication service server 116 looks up the submitted user ID in the authentication service database 136, as indicated at event 208. If the user ID is stored in the database 136, the server 116 determines if the submitted password is the same as the password stored in the database 136 and associated with the stored user ID. If the submitted user ID is found in the database 136 and the submitted password is associated with the submitted user ID in the database 136, the authentication service 116 validates or authenticates the login credentials.

When the authentication service 116 validates the login credentials of the consumer 104, the authentication service server 116 sends a token or message indicating a valid login and at least one unique identifier associated with the valid login credentials to the payment page 300 on the consumer computer 114, as indicated at event 210a. A coding instruction, such as, for example, Javascript or the like, included in the payment page 300, instructs the browser 124 to automatically send the unique identifier to the payment service server 112. As indicated at event 210b, the browser 124 automatically sends the valid login token or message and the at least one unique identifier to the payment service server 112.

The unique identifier is associated with the valid login credentials, which are in turn associated with the consumer 104. In an embodiment, the unique identifier is distinct from the login credentials. In another embodiment, the unique identifier comprises a subset of the login credentials, such as, for example, the user ID associated with the consumer 104 at the authentication service 116. In another embodiment, the unique identifier comprises the email address associated with the login credentials. In yet another embodiment, the unique identifier comprises the name associated with the login credentials, an Internet Protocol (IP) address, device identifiers, public keys, private keys, and the like.

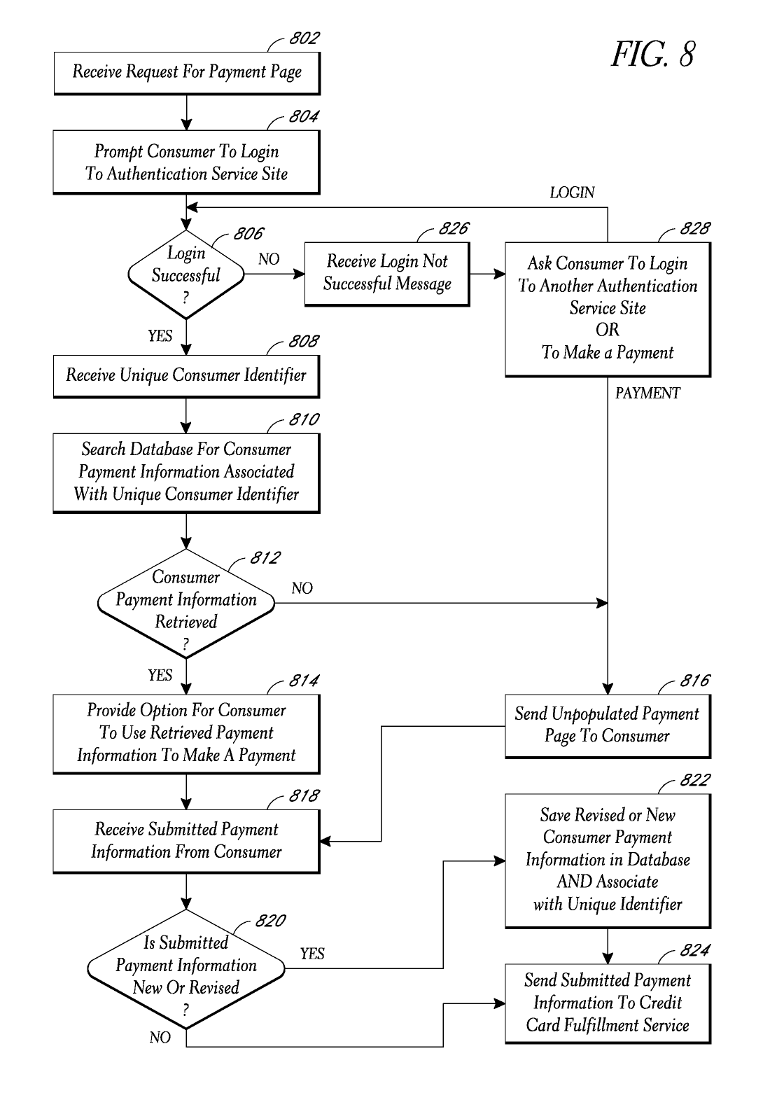

If the submitted user ID is not found in the database 136 or the submitted password is not associated with the submitted user ID in the database 136, the authentication service 106 does not validate or authenticate the login credentials. When the authentication service 106 does not validate the login credentials of the consumer 104, the authentication service server 116 sends a token or a message indicating an invalid log into the payment page 300 on the consumer computer 114. The browser 124 automatically sends the invalid login token or the invalid login message to the payment service server 112. As described below in FIG. 8, in one embodiment, the consumer 104 is given an option to log into another external authentication service 106. In another embodiment, the consumer 104 populates the payment page 300 and continues with the transaction.

For valid logins, the payment service server 112 receives the valid login token and unique identifier. At event 212, the server 112 looks up the unique identifier in the payment service database 132.

The payment service database 132 stores at least consumer information associated with the unique identifier. When the consumer 104 is making a payment via the payment service 102 for the first time, the payment service database 132 does not include consumer information associated with the unique identifier.

When the unique identifier is not found in the payment service database 132, the payment service server 112 sends an unpopulated payment page to the consumer computing device 114 through the browser 124, as indicated at event 214.

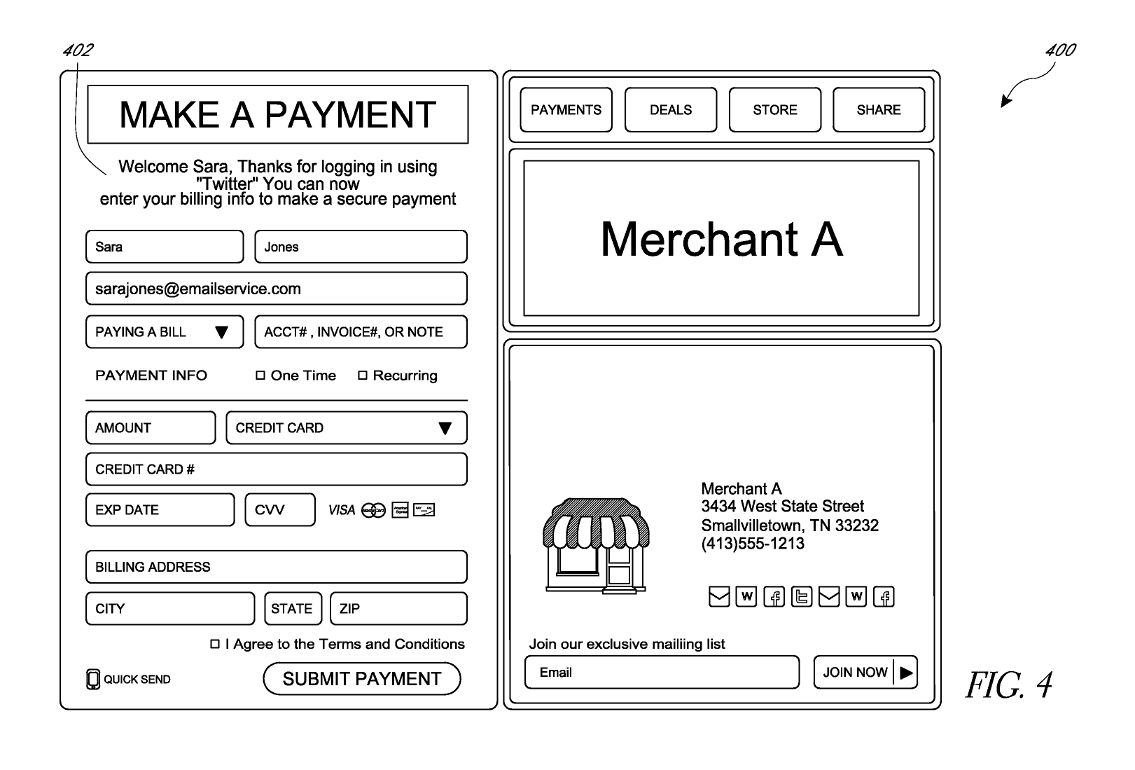

FIG. 4 illustrates an exemplary unpopulated web page 400 displayed to the consumer 104 after an unsuccessful authentication for the first transaction. The payment page 400 prompts the consumer 104 to enter his consumer information. In the illustrated example, the page 400 is personalized with the following message 402, which prompts the consumer 104 to enter consumer information: “Welcome Sara, Thanks for logging in using Twitter. You can now enter your billing information and make a secure payment.”

The payment page 400 has form entry fields for customer information, such as name and email address, type of activity, and payment information. In the illustrated embodiment, the type of activity comprises paying a bill, the associated account number, invoice number or note associated with the activity, and the like. In other embodiments, the type of activity can be paying an invoice, paying for products or services, or making a payment. In the illustrated embodiment, the payment information comprises a payment amount, a credit card brand, a credit card number, an expiration date, and the billing address of the credit card. In other embodiments, the payment page 400 includes form entry fields for a shipping address, the name on the credit card, a contact phone number, email address, and the like. To continue with the transaction, the consumer 104 enters the information, as indicated at event 216.

At event 218 of FIG. 2, the consumer submits the consumer information and the computing device 114, through the browser 124, sends the consumer information to the payment service server 112.

The payment service server 112 receives the consumer information. At event 220 of FIG. 2, the payment service server 112 saves the unique identifier and the consumer information, including the credit card number, in the database 132, and associates the unique identifier with the saved consumer information. The consumer information is now available for subsequent transactions.

At event 222 of FIG. 2, the payment service server 112 sends transaction information to the credit card fulfillment service server 118. In an embodiment, the transaction information comprises the credit card information, the payment amount, and merchant information, such as the merchant's bank account, for example. In other embodiments, the transaction information further comprises merchant ID, purchase transaction ID, or the like. In an embodiment, to complete the transaction, the credit card fulfillment service server 118 interfaces with the credit card company server to debit the payment amount from the credit card account and with the server of the financial institution associated with the merchant to credit the payment amount to the merchant account.

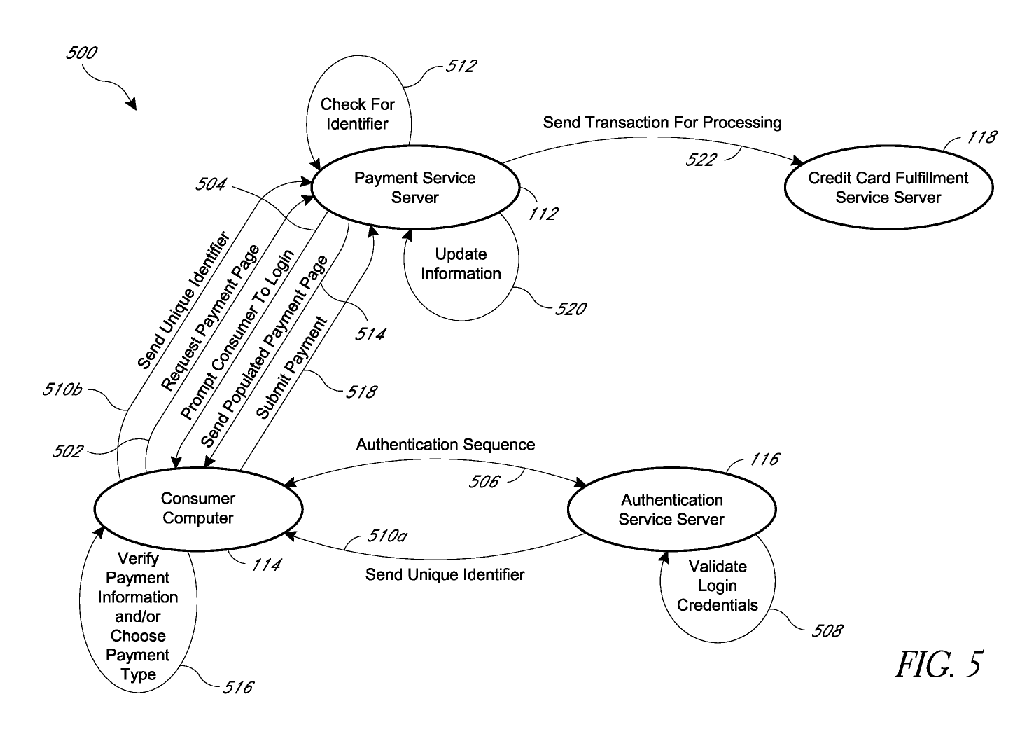

FIG. 5 illustrates an exemplary data flow diagram 500 showing the transfer of information between the payment service server 112, the consumer computer 114, the authentication service server 116, and the credit card fulfillment service server 118 for a second transaction. The second transaction is any transaction after the first transaction from the same consumer 104 as in the first transaction with any merchant that is associated with the payment service 102. In other words, the merchant in the second transaction can be the same or different from the merchant in the first transaction, as long as both merchants are associated with or have an account with the payment service 102.

Beginning with event 502, the consumer 104 through the browser 124 and the computing device 114 requests a payment page associated with the merchant.

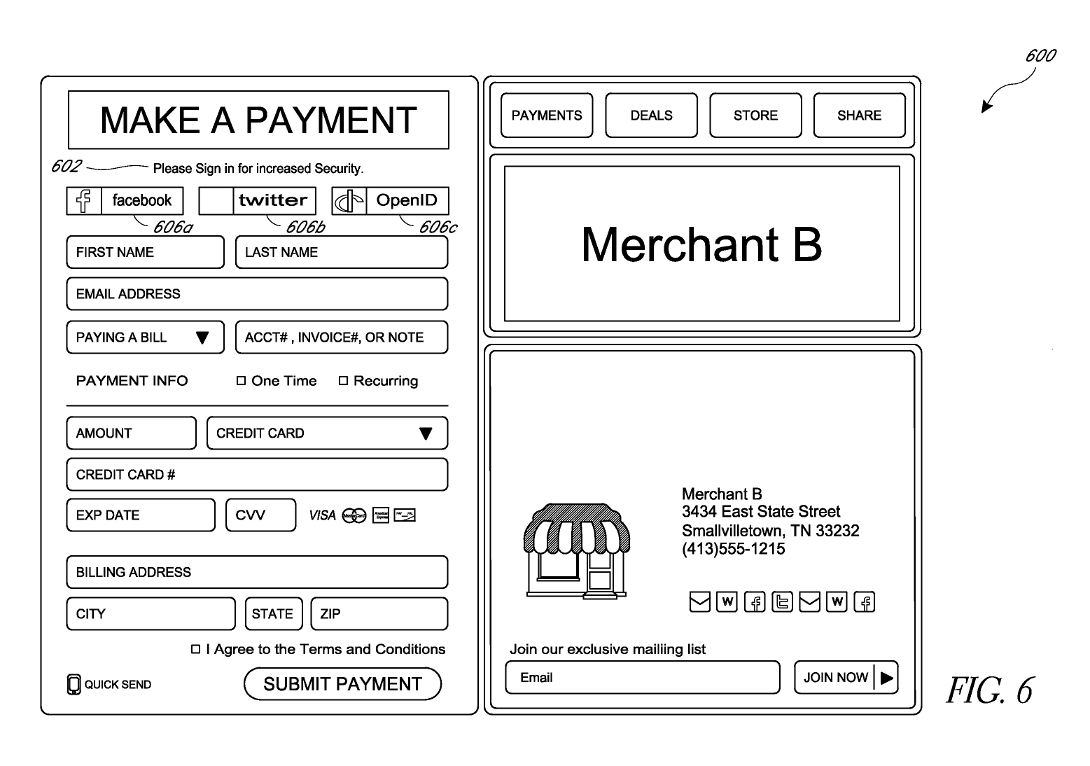

FIG. 6 illustrates an exemplary payment page 600 displayed to the consumer 104 before authentication in connection with the second transaction. In the illustrated embodiment, Merchant B, a hypothetical merchant, serves as the Internet merchant. The payment page 600 prompts the consumer 104 to log into an external authentication site, as indicated by event 504. In the illustrated example, a prompt 602 “Please sign in for increased security” prompts the consumer 104 to select an external authentication service 106, such as a social networking service, a social media service, a mobile phone number, or a webmail service. In the illustrated example, the consumer 104 selects from one of the social networking sites, Facebook 606a, twitter 606b, and OpenID 606c.

The process 500 at events 506, 508, 510a and 510b in FIG. 5 is the same as the process 200 at events 206, 208, 210a and 210b in FIG. 2, respectively. As described above with respect to event 206 of FIG. 2, the consumer 104 selects and logs into one of the presented external authentication services 106 as indicated at event 506. As described above with respect to event 208 of FIG. 2, the external authentication service 106 validates the login credentials according to the procedure in place at the selected external authentication service 106 as indicated at event 508. As described above with respect to events 210a and 210b of FIG. 2, after authentication, the authentication service server 116 sends a valid login indication and at least one unique identifier associated with the valid login to the payment page 600 via the consumer computer 114 and the browser 124, as indicated at events 510a and 510b.

For valid logins, the payment service server 112 receives the valid login token and at least one unique identifier. At event 512, the payment service server 112 searches for the unique identifier in the payment service database 132. When the unique identifier is found, the payment service server 112 retrieves the consumer information associated with the unique identifier from the payment service database 132. The payment service 102 obtains the consumer information stored in the payment service database 132 from at least one previous transaction conducted by the consumer 104 with any merchant associated with the payment service 102, such as the first transaction described above with respect to FIGS. 2, 3, and 4.

In an embodiment, as indicated at event 514, the payment service 102 provides an option for the consumer 104 to use the retrieved consumer information to make a payment to the merchant. In another embodiment, at event 514, the payment service server 112 populates the payment page with the consumer information, which includes the credit card number. In yet another embodiment, the payment service server 112 serves the computing device 114 through the browser 124 a new page including the retrieved consumer information, which includes the credit card number.

If the consumer information is not found in the payment service database 132, the payment service server 112 sends an unpopulated payment page to the consumer computing device 114 through the browser 124, as described below in FIG. 8. The consumer populates the payment page and continues with the transaction.

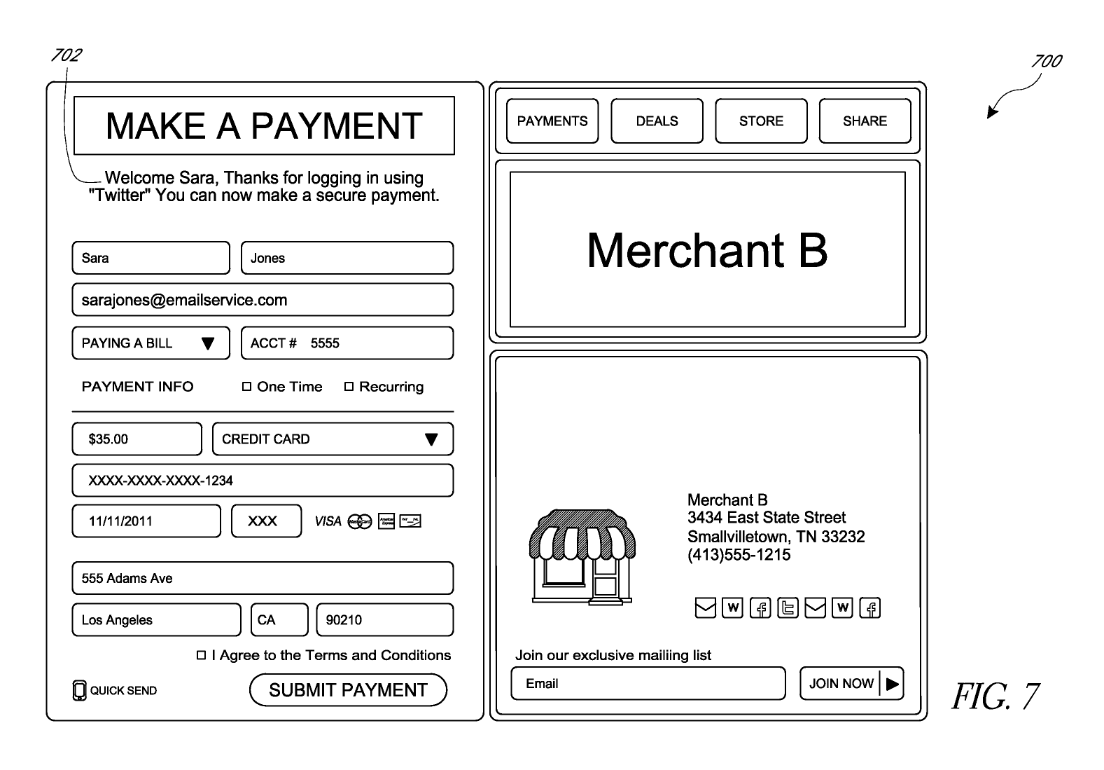

FIG. 7 illustrates an exemplary web page 700 displayed to the consumer 104 after authentication of the second transaction. The payment page 700 prompts the consumer 104 to verify the information. In one embodiment, payment page 700 includes the consumer information and the consumer 104 verifies the consumer information and enters the payment amount. In another embodiment, the server 112 supplies the consumer information, including the payment amount and the consumer 104 verifies the consumer information and the payment amount.

In the illustrated example, the page 700 is personalized with the following message 702, which prompts the consumer 104 to enter consumer information: “Welcome Sara, Thanks for logging in using Twitter. You can now enter your billing information and make a secure payment.”

The page 700 comprises populated form entry fields for customer information, such as name and email address, type of activity, and payment information. In the illustrated embodiment, the server 112 populated the consumer's name, email address, type of activity (paying a recurring bill to account number 5555), the amount to be charged to the displayed credit card number, the expiration date, and the billing address of the card. In other embodiments, other information stored in the database 132 and associated with the unique identifier, such as for example, the shipping address, the name on the credit card, the contact phone number, Geo IP locations, purchasing habits, styles, all merchants that have been shopped, other payment options such as automated clearing house (ACH), gift cards, alternative payment options, and the like, could be populated on the payment page 700.

At event 516, the consumer verifies the retrieved and populated information. In an embodiment desired, the consumer can update the information provided on the payment page 700. For example, if the consumer 104 has moved, the consumer 104 can revise the billing address associated with the credit card number. In an embodiment, when the database 132 includes more than one credit card number associated with the unique identifier, the consumer 104 chooses which credit card to use for the transaction. Further, the consumer 104 can indicates a different credit card to use for the transaction. To continue with the transaction, the consumer 104 verifies or revises the information.

At event 518, the consumer 104 submits the consumer information and the computing device 114 sends the consumer information to the payment service server 112.

The payment service server 112 receives the information. At event 520 of FIG. 5, the payment service server 112 determines whether the submitted consumer information includes any new or revised information, such as, for example, a new credit card number, a different billing address, or the like, that is not stored in the payment service database 132. If there is new and/or revised information, the payment service server 112 saves the information and associates the information with the unique identifier in the payment service database 132.

The process 500 at event 522 in FIG. 5 is the same as the process 200 at event 222 in FIG. 2. As described above with respect to event 222 of FIG. 2, the payment service server 112 sends transaction information comprising the credit card information, the payment amount, and merchant information to the credit card fulfillment service server 118, as indicated at event 522 of FIG. 5.

FIG. 8 is a flow chart illustrating a process 800 through which the consumer 104 has the option of using retrieved payment information from the payment service database 132 to make a payment to the merchant, according to an embodiment. The process 800 may be implemented in software code executed by a physical server or other computing system.

At block 802, the payment service server 112 receives a request for the payment page 300, 600 from the consumer computing device 114 through the browser 124. In another embodiment, the merchant server or a third-party entity receives the request for the payment page 300, 600.

At block 804, the payment service server 112 sends the payment page 300, 600 to the computing device 114. In other embodiments, the payment page 300, 600 is sent from the merchant server or a third-party entity server. The payment page 300, 600 prompts the consumer 104 to log into an external authentication service site 126. The external authentication service 106 is distinct from the payment service 102. A computing system 116, 126, 136 operated by the authentication service 106 is distinct from the computing system 112, 122, 132 operated by the payment service 102. In an embodiment, the external authentication service 106 is an authentication service of a social media site, a social networking site, a webmail provider, or the like.

At block 806, the payment service server 112 determines whether the login was successful. In an embodiment, the authentication service server 116 receives the login credentials from the consumer computing device 114 through the browser 124 and validates the login credentials according to the established procedure of the authentication service 106. The authentication service server 116 sends a token or other login indicator to the payment service server 112 via the computing device 114 and browser 124. The token indicates whether the login was successful and a successful login authenticates the consumer 104. Further, for a successful login, the authentication service server 116 also sends at least one unique identifier associated with the consumer 104 to the payment service server 112 via the computing device 114 and browser 124.

When the login is successful, the process 800 moves to block 808, where the payment service server 112 receives the unique consumer identifier from the authentication service server 116.

At block 810, the payment service server 112 searches the payment service database 132 for consumer information associated with the unique identifier. At block 812, the payment service server 112 determines whether consumer information associated with the unique identifier was found. If the payment service server 112 retrieves consumer information associated with the unique identifier from the database 132, the process 800 moves to block 814.

At block 814, the payment service server 112 provides the consumer 104 through the consumer computing device 114 and browser 124 the option of using the retrieved information to make a payment to the merchant. In an embodiment, the payment service server 112 populates the payment page 400, 700. In another embodiment, the payment service server 112 serves a new payment page including the consumer information to the consumer 104 through the browser 124 to the computing device 114. The consumer 104 verifies the populated consumer information, revises the information as applicable, and submits the payment page.

At block 818, the payment service server 112 receives the submitted consumer information, including the payment information, from the computing device 114.

At block 820, the payment service server 112 determines whether the submitted information includes revised or new information that was not previously stored in the payment service database 132.

If the submitted information is the same as the information retrieved from the database 132, the payment service server 112 at block 828 sends transaction information including the consumer information and the payment information to the credit card fulfillment service server 116, where the transaction is completed. In an embodiment, the credit card fulfillment service server 116 interfaces with the credit card server to debit the payment amount from the credit card account and interfaces with the server of the merchant's financial institution to credit the payment amount to the merchant account to complete the transaction.

When the login is unsuccessful at block 806, the process 800 moves to block 826, where the payment service server 112 receives an indication of the unsuccessful login from the authentication service server 116.

At block 828, the payment service server 112 sends a message to the consumer computing device 114 through the browser 124 that the login was unsuccessful and in an embodiment, gives the consumer 104 the option of logging into another authentication site 106, whose login prompt is found on the payment page 300, 600. If the consumer 104 chooses to log into another authentication service 106, the process 800 moves to block 806, where the payment service server 112 determines whether the login was successful.

At block 828, in another embodiment, the customer 104 also has the option of filling in and submitting the consumer information requested on the payment page 300, 600 to continue the transaction. If the consumer 104 chooses to enter and submit the requested information, the process moves to block 816.

When, at block 812, the payment service server 112 cannot retrieve the consumer information from the payment service database 132, the process 800 moves to block 816.

At block 816, the payment service server 112 serves an unpopulated payment page to the consumer computing device 114 through the browser 124. The consumer 104 completes and submits the requested consumer and payment information. The process 800 moves to block 818, where the payment service server 112 receives the consumer information from the computing device 114.

At block 820, as indicated above, the payment service server 112 determines whether the submitted information includes new or revised information. If the consumer information is different from the retrieved information, the process 800 moves to block 822, where the payment service server 112 saves the new/revised consumer information in the payment service database 132 and associates the new/revised information with the unique identifier.

The process 800 then moves to block 824, where the payment service server 112 sends the consumer information including the payment information as transaction information to the credit card fulfillment service server 116, where the transaction is completed as described above.

In another embodiment, rather than use an authentication service 106, the payment service 102 authenticates the consumers 104 via communications with mobile phones or other communication devices of such consumers. During the first transaction with the merchant associated with the payment service 102, the payment page prompts the consumer 104 to enter a mobile phone number of the consumer. After entering and submitting the mobile phone number, the payment service 102 sends a unique personal identification number (PIN) to the mobile phone of the consumer 104. In an embodiment, the PIN is sent via a text message, a short message service (SMS) message, a multimedia messaging service (MMS) message, an instant message, or the like. The consumer 104 enters the unique PIN into the authentication field, just like a password. The payment service 102 stores the mobile phone number in the payment service database 132 and associates the mobile phone number with the consumer information entered during the first transaction.

During any subsequent transaction with any merchant associated with the payment service 102, the payment page prompts the consumer 104 to enter the mobile phone number of the consumer. In one embodiment, the payment service 102 sends a PIN for the consumer to enter into the payment page, like a password. The payment service 102 automatically populates the secure payment information to the payment page or serves a payment page with the secure payment information populated. In another embodiment, when the consumers enters the mobile phone number a unique link is sent via SMS/text or other message to the mobile phone or mobile device. When the consumer selects/clicks the link, the payment service 102 automatically populates the secure payment information to the payment page or serves a payment page with the secure payment information populated. In this process, the payment service 102 also functions as the authentication service 106 and the mobile phone number is the unique identifier. Other aspects of this process, such as the interactions between the payment service server 112 and the consumer computer 114 and the interactions between the payment service server 112 and the credit card fulfillment server 118, are substantially the same as shown in FIGS. 2 and 5 and described above.

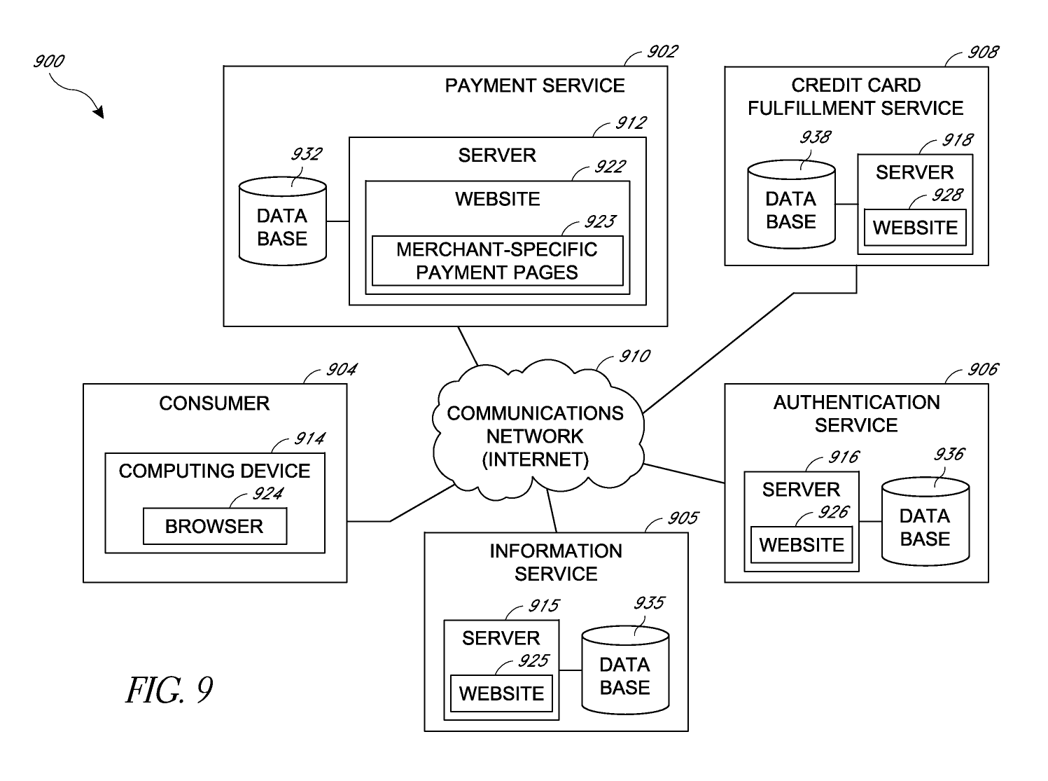

In other embodiments of the payment service, described below with respect to FIGS. 9-16, the user requests authentication for a payment transaction from an external authentication service. Examples of payment transactions are, but not limited to credit card transactions, automatic clearing house (ACH) transactions, and the like. In an embodiment, the external authentication service comprises a social media service. In another embodiment, the external authentication service comprises a credit service. Typically a credit service is an entity that provides and/or stores credit information for consumers having one or more credit cards, provides credit scores for consumers having or desiring credit, and the like. Credit services are, for example, information services, credit reporting services, credit bureaus, credit unions, credit card companies, banks, lending institutions, payment institutions and the like.

In an embodiment, the credit service provides the credit card numbers associated with the unique identifier provided by the authentication service. In some embodiments, the authentication service is an authentication service associated with the information or credit service. In other embodiments, the authentication service is distinct from both the payment service and the information or credit service.

In some embodiments, the payment service stores the credit card number provided by the information or credit service for a consumer's first transaction in the payment service database and retrieves the credit card number for subsequent purchases by the consumer for any merchant associated with the payments service.

In other embodiments, the payment service stores at least a portion of the credit card number provided by the information or credit service. The at least a portion may comprise the last four digits of the credit card number. In further embodiments, the payment service does not store any portion of the credit card number. In such embodiments where the payment service does not store a complete credit card number associated with the unique identifier of the consumer, the payment service requests and receives from the information or credit service the credit card number for each transaction for any merchant associated with the payment service.

In certain embodiments, the payment service stores consumer information associated with the unique identifier in the payment service database. Consumer information comprises the user's name, billing address, shipping address(es), email address, transaction history, past merchant names and addresses, credit card brand, credit card expirations date, and the like, and may or may not store the credit card number. The information or credit service may provide, in addition to the credit card number, the credit card brand, the expiration date, and the like that is used to complete a credit card transaction.

FIGS. 9-16 describe exemplary embodiments comprising a computer-implemented payment service that enables users to use account information from an external service, such as a social media service, an information service, a credit service, and the like to make payments to merchants. The payment service advantageously enables users to make payments to merchants (and/or other types of entities) without establishing login accounts with such merchants, and without having to create a login account with the payment service. In some embodiments, the system that hosts the payment service also hosts merchant-specific payment pages that can be accessed by users to initiate payments to the merchant. The system may also host tools for enabling merchants to create and customize their respective payment pages.

In a typical scenario, the user browses to a payment page of a merchant having an account with the payment service. The payment page includes a prompt for prompting the user to log into one or more authentication services, such as social media sites, information service sites, credit service sites, and links to the authentication service of the one or more sites. From there, the user selects the option to authorize the payment with the payment service using the user's login credentials for a particular authentication service. The user selects a particular authentication service and enters his login credentials. The selected authentication service site receives the login credentials and authorizes the user.

The authentication service of the selected site sends to the payment service via the user's computer a valid authorization message and a unique identifier associated with the user. The payment service receives over a network the valid authorization message and the unique user identifier from the authentication service. The payment service retrieves consumer information of the user, such as the user billing address, the user shipping address, and the like from its database based at least partly on the unique user identifier received from the authentication service. The consumer information was obtained by the payment service based on a previous payment transaction conducted by the user.

The payment service sends the unique user identifier and requests a credit card number associated with the user from the information service. The information service sends to the payment service credit card information associated with the user based at least partly on the unique user identifier and the payment service receives over a network the credit card information associated with the user. The credit card information comprises one or more of a credit card number, a credit card brand, and an expiration date. The payment service then provides the user with an option to use the retrieved consumer information and received credit card information to make a payment to the merchant. In an embodiment, the payment service populates the payment page with the retrieved payment information and at least a portion of the received credit card number to provide payment information. The user verifies the payment information and submits the populated payment page to the payment service.

For a more detailed understanding of one embodiment of the invention, reference is first made to FIG. 9. FIG. 9 illustrates the principal components of an embodiment of another transaction system 900 that permits users to make payments to merchants. A consumer 904 can be any individual or other entity that wishes to make purchases of products or services from a merchant. In order to select and purchase products or services or make other payments, the customer preferably uses a web or mobile browser 924 running on a computing device 914. The computing device 914 can be any device that allows the consumer 904 to interact with the system 900, such as, for example, a conventional computer and modem, an interactive wireless communications device, a laptop, an iPAD, an iPhone, a smartphone, a personal digital assistant, an interactive television, a game console, or the like.

The merchant is an entity that collects payments from consumers 904. In some cases, the merchant may sell products to the consumers 904 and use the payment service to collect payments from the consumers 904. In other cases, the merchants may include service providers (e.g., fitness centers, tutoring services, etc.) that use the payment service to collect payments from the consumers 904. In other examples, the merchants may include charitable organizations that use the payment service to accept donations from consumers 904. The payments can be for a one-time transaction for the purchase of a particular good or service, or the payments can be recurring transactions, such as monthly electric company payments, monthly fitness center charges, and the like.

In order to process transactions, merchants typically require consumer and payment information. Consumer information may include, for example, the consumer's name, the consumer's address, shipping address(es), email address, and the like, and payment information, may include, for example, a credit card number, expiration date, and billing address, and the like. Typically, merchants accept credit card payments from authenticated users or consumers to increase the likelihood that the consumer information is trustworthy and decrease the likelihood of fraud. In addition to providing consumer information, the consumer 904 is often asked to provide authentication information, such as, for example, a user identification (user ID) and password. If the consumer 904 has not previously set up an account with the merchant, then the consumer 904 is further burdened with the task of setting up an account with the merchant in order to be associated with the authentication information. In some instances, the consumer 904 decides to abort the purchase rather than spend time entering consumer information, authentication information, and account information. To avoid losing sales, the merchant uses a payment service 902 to provide the authenticated consumer and payment information to the consumer 904. The consumer 904 easily verifies the provided consumer and payment information and verifies the payment amount or enters the payment amount before submitting the purchase.

The payment service 902 is a computer-implemented service that hosts merchant-specific payment pages 923 of registered merchants. Through these payment pages 923, consumers 904 can make online payments to the corresponding merchants using authenticated consumer and payment information provided by the payment service 902. In one embodiment, the payment service 902 enables merchants to sell items online or to otherwise collect payments without the need to create or operate a web site.

In other embodiments, the merchant may host the payment page on a web site that it operates. In yet further embodiments, a third-party may host the payment pages.

The payment service 902 can interface with merchants and consumers 904 through a payment service web site 922 hosted by a server 912. (Each server shown in FIG. 9, including the payment service server 912, may include one or more computing devices, such as one or more physical servers.) In the embodiment illustrated in FIG. 9, the payment service web site 922 includes the merchant-specific payment pages 923. In an embodiment, the payment service 902 assigns to each payment page 923 a unique uniform resource locator (URL), such as, for example, www.payservice.com/merchantA, www.merchantA.payservice.com, or the like. The payment service server 912 accesses a payment service database 932, which stores consumer information.

The merchant is associated with the payment service 902 by, for example, subscribing to the payment service 902, having an account with the payment service 902, and the like. Individual merchants, upon enrolling online with the payment service 902, can set up one or more customized payment pages 923. These payment pages 923 can include descriptions of specific products, services, or other items that are available to consumers 904. In other cases, a merchant can set up a payment page 923 than enables consumers 904 to pay their monthly or other bills. As described above, the payment service 902 can assign to each payment page 923 a unique uniform resource locator (URL). Merchants can send out the URL for one or more payment pages 923 to their customers 904 to allow the customers to use the payment page for payments to the merchant. In other cases, the merchants can provide a link from their web sites to the payment page 923. Merchants, upon enrolling, can either enter their preexisting merchant bank account information, request that the payment service 902 set up a merchant bank account to receive the payments, use a third party master merchant account, use an Internet Payment Service Provider (ISPS) account, or the like.

To avoid having consumers 904 provide authentication information that is specific to a particular merchant, the payment service 902 prompts consumers 904 to log into an external authentication service 906 using their existing authentication information for the particular authentication service. Although a single authentication service 906 is shown, the payment service 902 may interact with multiple distinct authentication services 906 associated with multiple distinct services or sites. In an embodiment, the authentication service 906 is part of a social media service, social networking service, or webmail service, as described above. In another embodiment, the authentication service 906 is an authorization function of an information service, a credit service, and the like.

The authentication service 906 is accessible through a web site 926, which is implemented using a server 916. The authentication service server 916 accesses an authentication service database 936, which stores authentication information for the particular authentication service. The authentication service server 916 sends to the payment service server 912 via the computing device 914 and the browser 924 a unique identifier associated with the consumer 904 when the authentication service 906 authenticates the consumer 904.

After receiving an indication that the consumer is authenticated, the payment service server 912 requests credit card information associated with the consumer 904 from an information or credit service 905. The information service 905 is accessible through a web site 925, which is implemented using a server 915. The information service server 915 accesses an information service database 935, which stores credit card information.

The information or credit service 905 is preferably an entity such as a credit bureau that stores credit reporting information. The credit card information stored in the information service database 935 is the result of credit-related events reported to the information service 905 by entities which provide or accept credit, such for example, banks, utility companies, department stores, and the like. The information service server 915 accesses the information service database 935, and retrieves the credit card information associated with the consumer 904 based at least in part on the unique identifier. The information service server 915 sends to the payment service server 912 the credit card information associated with the consumer 904. In an embodiment, the consumer 904 creates an account, such as an online account, with the information service 905 to allow the information service 905 to access the consumer's credit card information.

The payment service server 912 retrieves consumer information associated with the unique identifier from the payment service database 932 and provides the consumer information and the credit card information to the computing device 914 through the browser 924. The consumer 904 reviews the provided consumer and credit card information and, optionally, submits the information to make a payment to the merchant. The payment service 902 serves the payment information to a credit card fulfillment service 908.

The credit card fulfillment service 908 is preferably an entity that specializes in account processing for payments made via credit card from a credit card fulfillment web site 928, which is implemented using a server 918. The server 918 accesses fulfillment information via a fulfillment database 938. The credit card fulfillment service 908 receives the payment information, charges the consumer's credit card, and credits the merchant's account.

In the context of the present disclosure, actions indicated as being taken by the payment service 902 are preferably performed by or through, as applicable, the payment service server 912 and its associated software components. Actions indicated as being taken by the consumer 904 are preferably performed by or through, as applicable, the web or mobile browser 924 and/or the computing device 914. Actions indicated as being taken by the authentication service 906 are preferably performed by or through, as applicable, the authentication service server 916 and its associated software components. Actions indicated as being taken by the information service 905 are preferably performed by or through, as applicable, the information service server 915 which may include multiple distinct computers or computing devices and its associated software components. Actions indicated as being taken by the credit card fulfillment service 908 are preferably performed by or through, as applicable, the authentication service server 918 and its associated software components.

Each of the functional components shown in FIG. 9 may be implemented in program code executed by one or more general or special purpose computers. The databases 932, 935, 936, and 938 can comprise one or more logical and/or physical data storage systems for storing data and applications used by the servers 912, 915, 916, and 918, respectively.

The payment service server 912, the computing device 914, the information service server 915, the authentication service server 916, and the credit card fulfillment service server 918 connect to a communications network 910, which preferably is or includes the Internet.

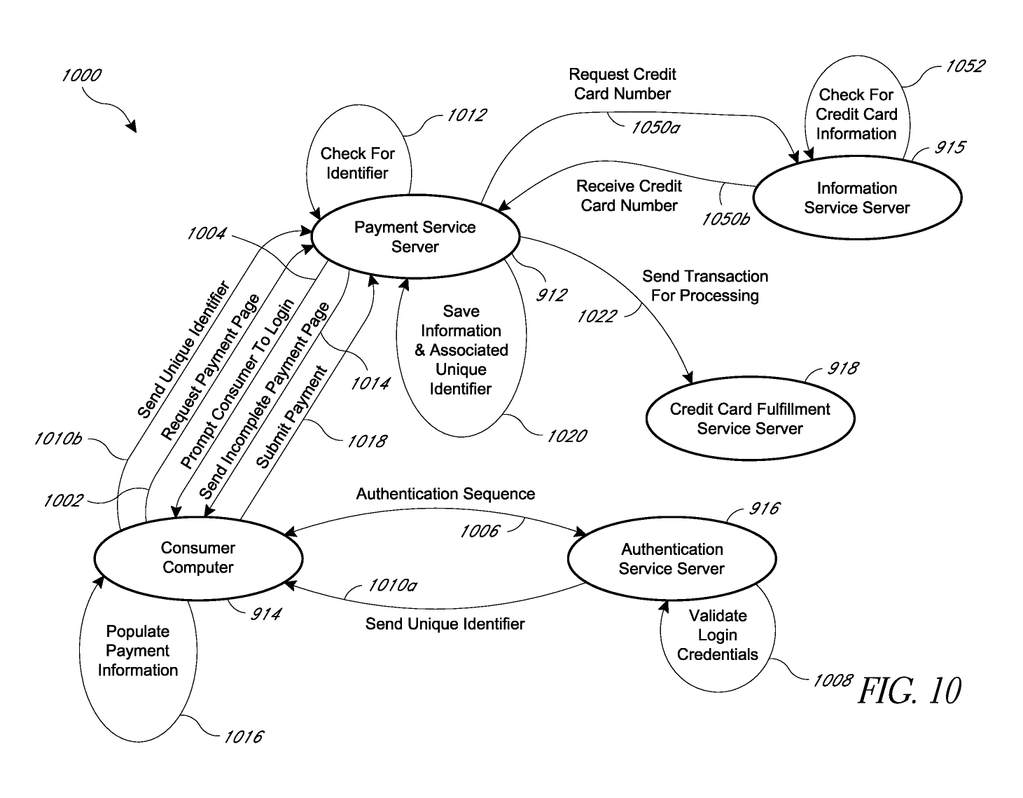

FIG. 10 illustrates an exemplary data flow diagram 1000 showing the transfer of information between the payment service server 912, the consumer computer 914, the information service server 915, the authentication service server 916, and the credit card fulfillment service server 918 for a first transaction. The first transaction is the first time the consumer 904 is making a payment through the payment service 902.

In a typical use case scenario, a consumer 904 initially accesses a merchant-specific payment page (not shown) that corresponds to a particular item that is available from the corresponding merchant. More specifically, in event 1002 of FIG. 10, the consumer 904, through the browser 924 and the computing device 914 requests a payment page associated with the merchant.

In an embodiment, the payment service 902 hosts the payment page and the payment service server 912 serves the payment page to the consumer computer 914, as indicated by event 1004. In another embodiment, the merchant hosts the payment page and the merchant server serves the payment page to the consumer computer 914. In yet another embodiment, a third-party entity hosts the payment page and a server of the third-party serves the payment page to the consumer computer 914.

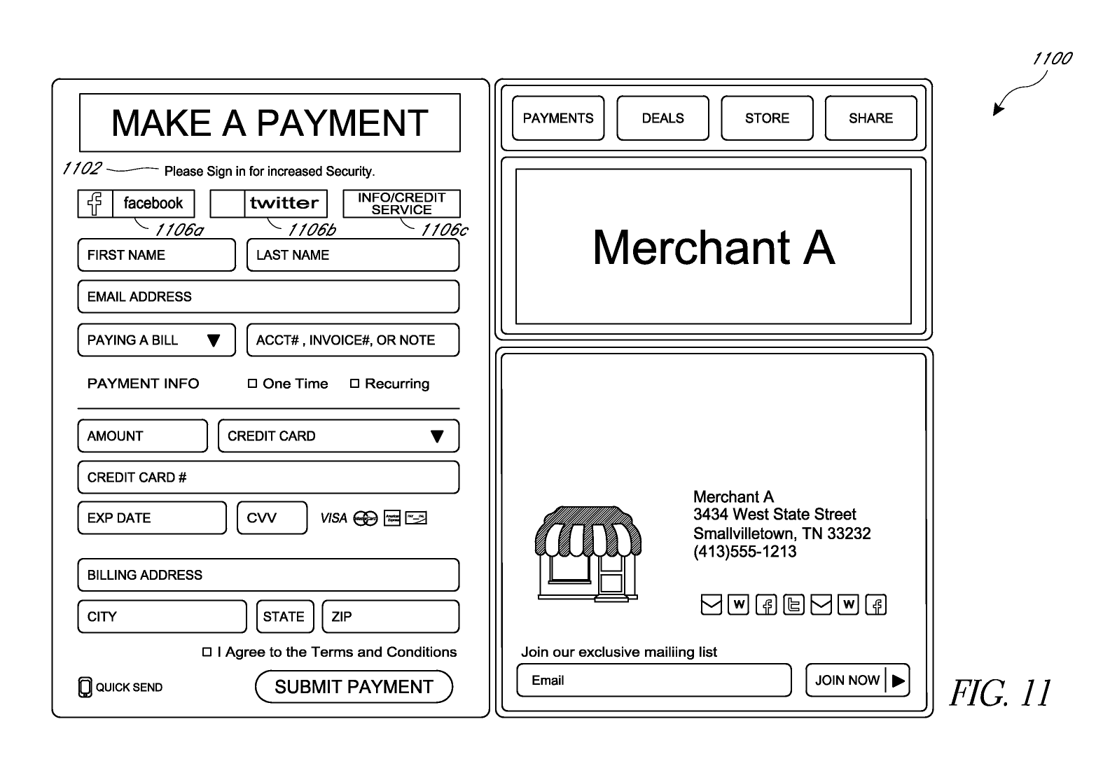

FIG. 11 illustrates an exemplary payment page 1100 displayed to the consumer 904 before authentication of the first transaction. In the illustrated embodiment, Merchant A, a hypothetical merchant, serves as the Internet merchant. The payment page 1100 prompts the consumer 904 to log into an external authentication site, as indicated by event 1004. In the illustrated example, a prompt 1102 “Please sign in for increased security” prompts the consumer 904 to select an external authentication service 906, such as a social networking service, or an information/credit service. In the illustrated example, the consumer 104 selects from one of Facebook 1106a, twitter 1106b, and INFO/CREDIT SERVICE 1106c.

Referring to FIG. 10, at event 1006, the consumer 904 selects one of the presented external authentication services 906. The external authentication service server 916 receives the login request and the external authentication service server 916 serves the consumer computer 914 with a login page or other object through an application programming interface of the external authentication service 906. The consumer 904 enters the login information or login credentials, such as, for example, a user ID and a password, associated with the consumer 904 for the selected external authentication service 906. The external authentication service 906 validates the login credentials according to the procedure in place at the selected external authentication service 906.

In one embodiment, for example, the authentication service server 916 looks up the submitted user ID in the authentication service database 936, as indicated at event 1008. If the user ID is stored in the database 936, the server 916 determines if the submitted password is the same as the password stored in the database 936 and associated with the stored user ID. If the submitted user ID is found in the database 936 and the submitted password is associated with the submitted user ID in the database 936, the authentication service 916 validates or authenticates the login credentials.

When the authentication service 916 validates the login credentials of the consumer 904, the authentication service server 916 sends a token or message indicating a valid login and at least one unique identifier associated with the valid login credentials to the payment page 1100 on the consumer computer 914, as indicated at event 1010a. A coding instruction, such as, for example, Javascript or the like, included in the payment page 1100, instructs the browser 924 to automatically send the unique identifier to the payment service server 912. As indicated at event 1010b, the browser 924 automatically sends the valid login token or message and the at least one unique identifier to the payment service server 912.

The unique identifier is associated with the valid login credentials, which are in turn associated with the consumer 904. In an embodiment, the unique identifier is distinct from the login credentials. In another embodiment, the unique identifier comprises a subset of the login credentials, such as, for example, the user ID associated with the consumer 904 at the authentication service 916. In another embodiment, the unique identifier comprises the email address associated with the login credentials. In yet another embodiment, the unique identifier comprises the name associated with the login credentials, an Internet Protocol (IP) address, device identifiers, public keys, private keys, and the like. In a further embodiment, the unique identifier comprises a portion of a credit card number.

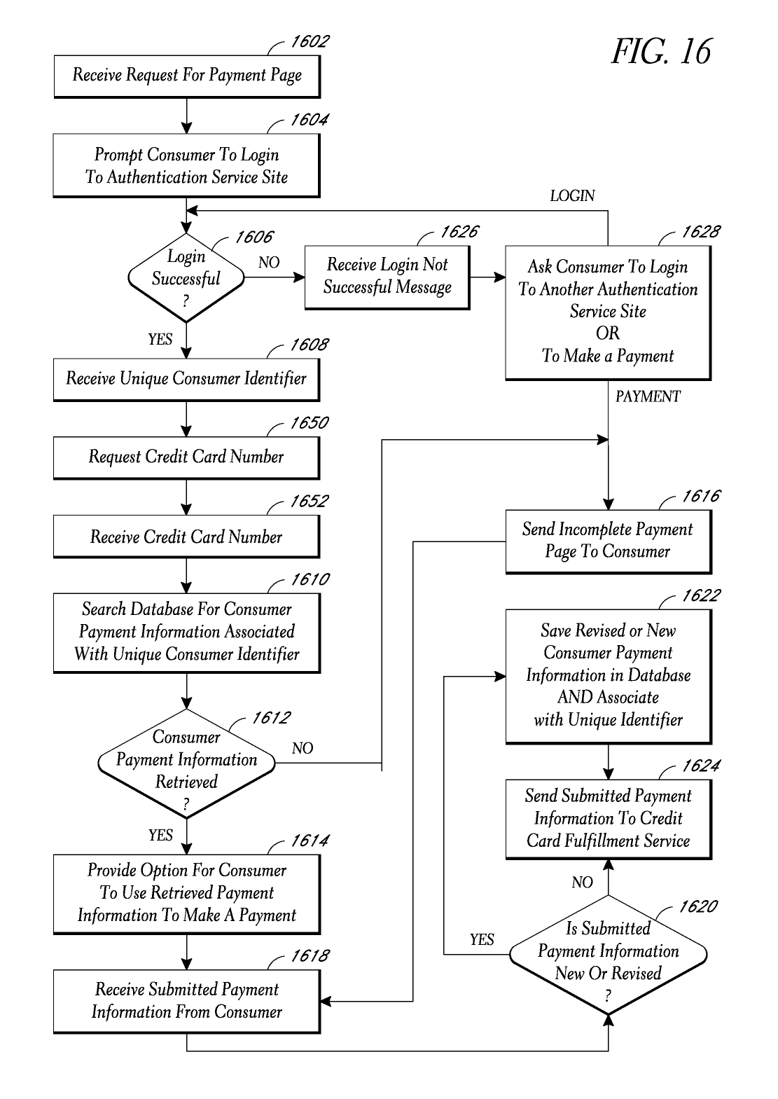

If the submitted user ID is not found in the database 936 or the submitted password is not associated with the submitted user ID in the database 936, the authentication service 906 does not validate or authenticate the login credentials. When the authentication service 906 does not validate the login credentials of the consumer 904, the authentication service server 916 sends a token or a message indicating an invalid log into the payment page 1100 on the consumer computer 914. The browser 924 automatically sends the invalid login token or the invalid login message to the payment service server 912. As described below in FIG. 16, in one embodiment, the consumer 904 is given an option to log into another external authentication service 906. In another embodiment, the consumer 904 populates the payment page 1100 and continues with the transaction.

For valid logins, the payment service server 912 receives the valid login token and unique identifier.

At event 1050a the payment service server 912 requests credit card information from the information service server 915. In an embodiment, the payment service server 912 requests the credit card number associated with the consumer 904. In another embodiment, the payment service server 914 sends the unique identifier with the request for the credit card information.

The information service server 915 receives the request for credit card information from the payment service server 912. The information service database 935 stores at least credit card information associated with the consumer 904. In another embodiment, the information service database 935 stores at least a credit card number associated with the consumer 904. At event 1052, the server 915 looks up the credit card information in the database 935, based partly on the unique identifier.

At event 1050b, the information service server 915 sends to the payment service server 912 the credit card information associated with the consumer 904. In an embodiment, the information service server sends at least the credit card number associated with the consumer 904. In another embodiment, the information service server 915 sends at least one partial or masked credit card number associated with the consumer 904. For example, the information service server 915 sends more than one partial or masked credit card number associated with the consumer 904, such that the consumer 904 can choose which credit card to use for the payment. For example, a masked credit card number comprises the last four digits or some other subset of the digits of the credit card number and the remaining digits are masked.

At event 1012, the server 912 looks up the unique identifier in the payment service database 932.

The payment service database 932 stores at least consumer information associated with the unique identifier. Examples of consumer information are the consumer billing address, the consumer shipping address, past purchases, merchants receiving previous payments, and the like. When the consumer 904 is making a payment via the payment service 902 for the first time, the payment service database 932 does not include consumer information associated with the unique identifier.

When the unique identifier is not found in the payment service database 932, the payment service server 912 sends an incomplete payment page to the consumer computing device 914 through the browser 924, as indicated at event 1014. The incomplete payment page comprises the credit card information received from the information service 905, but does not include consumer information associated with the unique identifier.

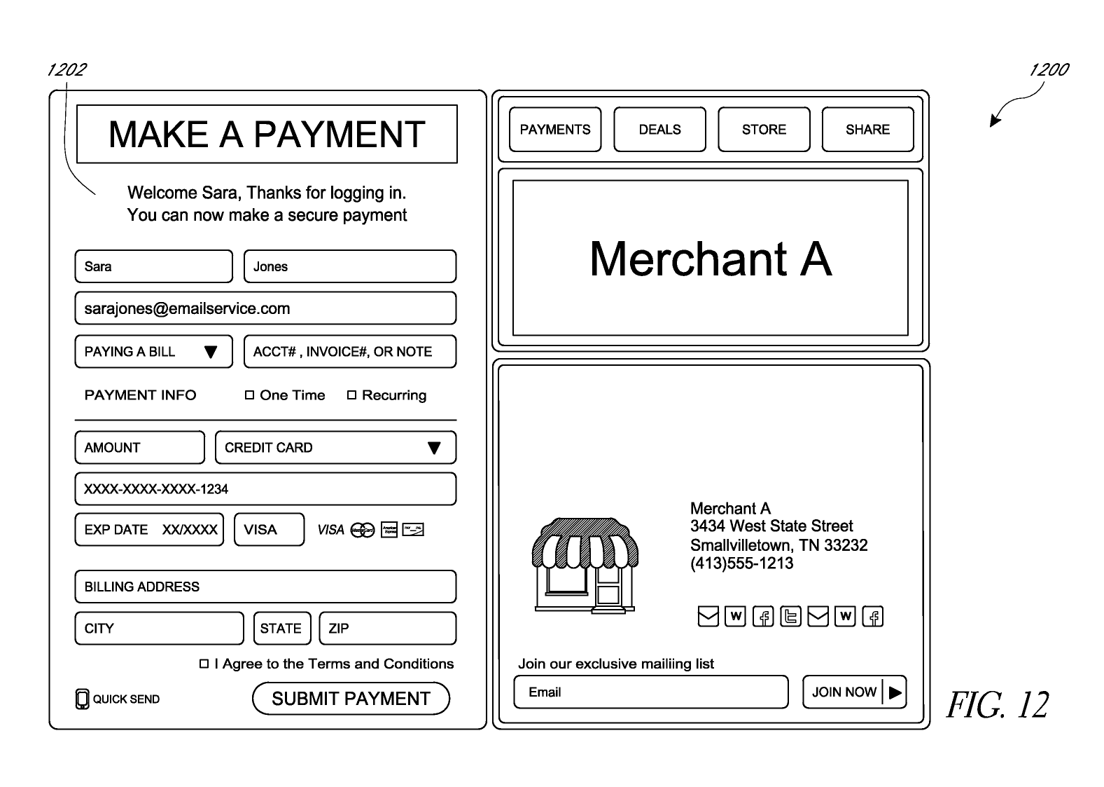

FIG. 12 illustrates an exemplary incomplete web page 1200 displayed to the consumer 904 after a successful authentication for the first transaction. The payment page 1200 displays at least a portion of the credit card number, credit card brand, expiration date, and the name on the credit card, which were received from the information service 905, and prompts the consumer 904 to enter his consumer information. In the illustrated example, the page 12400 is personalized with the following message 1202, which prompts the consumer 904 to enter consumer information: “Welcome Sara, Thanks for logging in. You can now enter your billing information and make a secure payment.”

The payment page 1200 has form entry fields for customer information, such as name and email address, type of activity, and payment information. In the illustrated embodiment, the type of activity comprises paying a bill, the associated account number, invoice number or note associated with the activity, and the like. In other embodiments, the type of activity can be paying an invoice, paying for products or services, or making a payment. In the illustrated embodiment, the payment information comprises a payment amount, and the billing address of the credit card. In other embodiments, the payment page 1200 includes form entry fields for a shipping address, the name on the credit card, a contact phone number, email address, and the like. In embodiments where the payment page 1200 comprises more than one masked credit card number, the consumer selects which credit card number to use for the payment. To continue with the transaction, the consumer 104 enters the information, as indicated at event 1016.

At event 1018 of FIG. 10, the consumer submits the consumer information and the computing device 914, through the browser 924, sends the payment page to the payment service server 912.

The payment service server 912 receives the payment page. At event 1020 of FIG. 10, the payment service server 1012 saves the unique identifier and the consumer information, excluding the credit card number, in the database 932, and associates the unique identifier with the saved consumer information. In another embodiment, at event 1020, the payment service server 1012 saves the unique identifier and the consumer information, including the credit card number, in the database 932, and associates the unique identifier with the saved consumer information. The consumer information is now available for subsequent transactions.

For embodiments where the information service server 915 sends one or more partial or masked credit card numbers in response to the previous request for the consumer's credit card number, the payment service server 912 repeats events 1050a and 1050b to acquire the complete credit card number. At event 1050a, the payment service server 912 requests the complete credit card number associated with the consumer's selection on the payment page from the information service server 915. At event 1050b, the payment service server 912 receives from the information service server 915 the complete credit card number for the consumer's selected credit card.

At event 1022 of FIG. 10, the payment service server 912 sends transaction information to the credit card fulfillment service server 918. In an embodiment, the transaction information comprises the credit card information, the payment amount, and merchant information, such as the merchant's bank account, for example. In other embodiments, the transaction information further comprises merchant ID, purchase transaction ID, or the like. In an embodiment, to complete the transaction, the credit card fulfillment service server 918 interfaces with the credit card company server to debit the payment amount from the credit card account and with the server of the financial institution associated with the merchant to credit the payment amount to the merchant account.

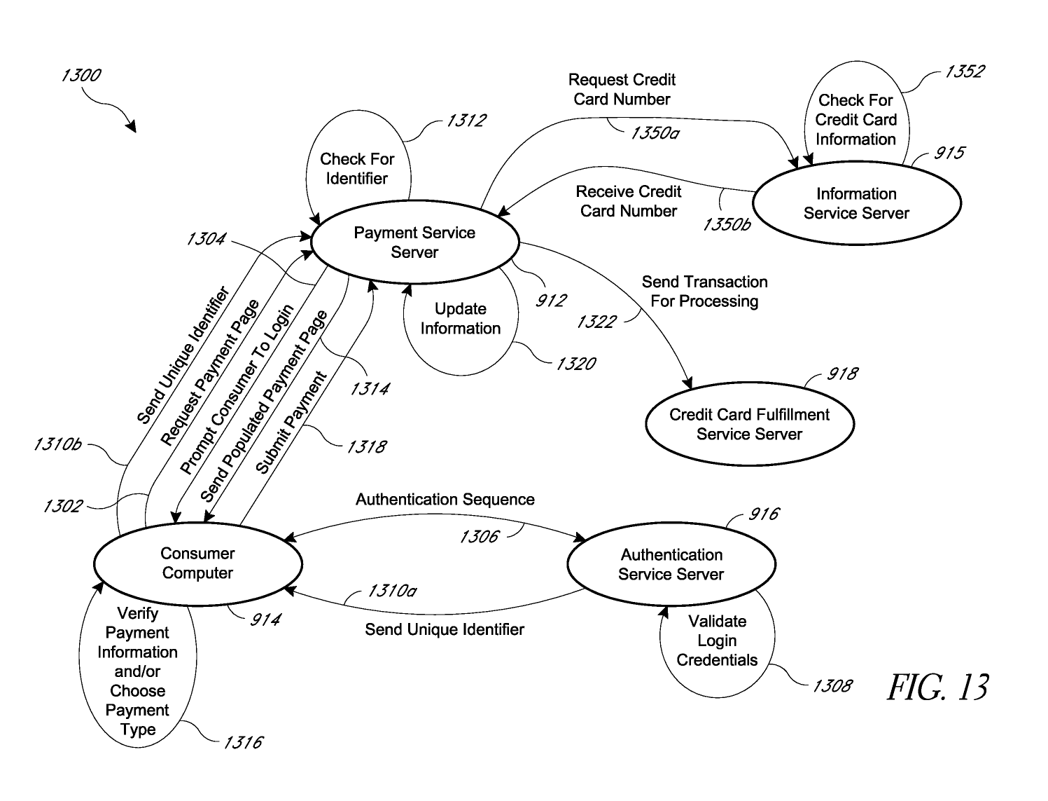

FIG. 13 illustrates an exemplary data flow diagram 1300 showing the transfer of information between the payment service server 912, the consumer computer 914, the information service server 915, the authentication service server 916, and the credit card fulfillment service server 918 for a second transaction. The second transaction is any transaction after the first transaction from the same consumer 904 as in the first transaction with any merchant that is associated with the payment service 902. In other words, the merchant in the second transaction can be the same or different from the merchant in the first transaction, as long as both merchants are associated with or have an account with the payment service 902.

Beginning with event 1302, the consumer 904 through the browser 924 and the computing device 914 requests a payment page associated with the merchant.

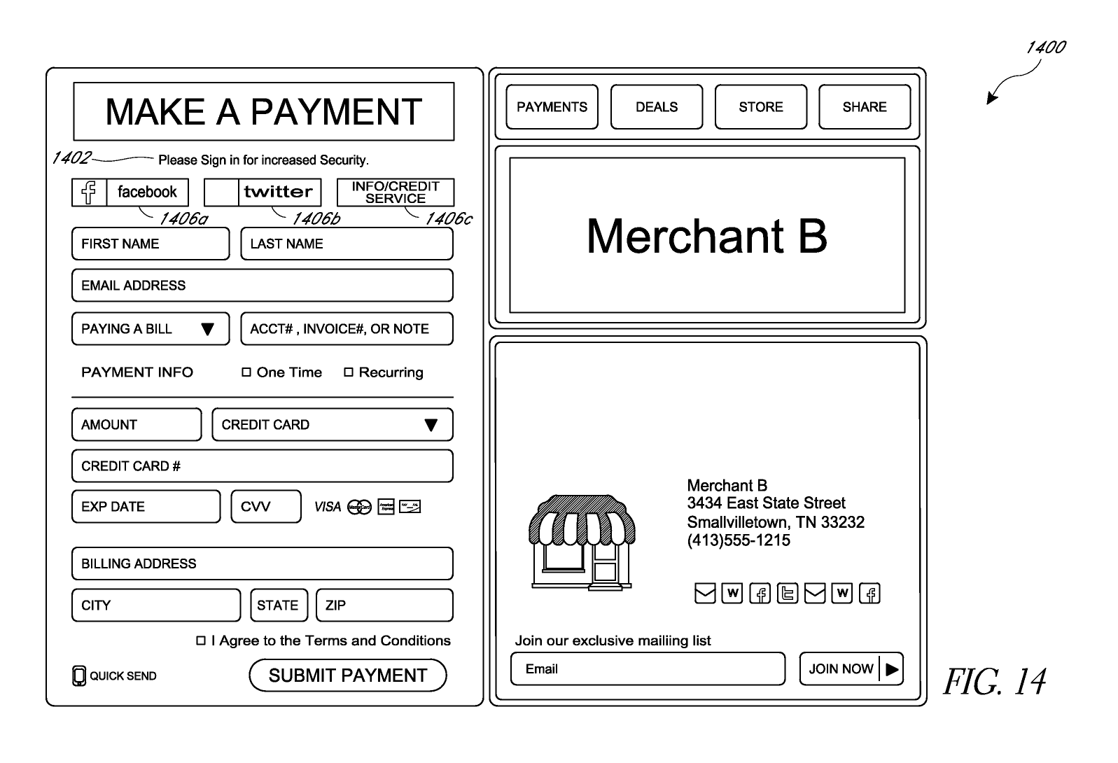

FIG. 14 illustrates an exemplary payment page 1400 displayed to the consumer 904 before authentication in connection with the second transaction. In the illustrated embodiment, Merchant B, a hypothetical merchant, serves as the Internet merchant. The payment page 1400 prompts the consumer 904 to log into an external authentication site, as indicated by event 1304. In the illustrated example, a prompt 1402 “Please sign in for increased security” prompts the consumer 904 to select an external authentication service 906, such as a social networking service, an information service, or a credit service. In the illustrated example, the consumer 104 selects from one of Facebook 1406a, twitter 1406b, and INFO/CREDIT SERVICE 1406c.

The process 1300 at events 1306, 1308, 1310a and 1310b in FIG. 13 is the same as the process 1000 at events 1006, 1008, 1010a and 1010b in FIG. 10, respectively. As described above with respect to event 1006 of FIG. 10, the consumer 904 selects and logs into one of the presented external authentication services 906 as indicated at event 1306. As described above with respect to event 1008 of FIG. 10, the external authentication service 906 validates the login credentials according to the procedure in place at the selected external authentication service 906 as indicated at event 1308. As described above with respect to events 1010a and 1010b of FIG. 10, after authentication, the authentication service server 916 sends a valid login indication and at least one unique identifier associated with the valid login to the payment page 1400 via the consumer computer 914 and the browser 924, as indicated at events 1310a and 1310b.

For valid logins, the payment service server 912 receives the valid login token and at least one unique identifier.

At event 1312, the payment service server 912 searches for the unique identifier in the payment service database 932. When the unique identifier is found, the payment service server 912 retrieves the consumer information associated with the unique identifier from the payment service database 932. The payment service 902 obtains the consumer information, such as, for example, the credit card brand, the expiration date, the billing address, the shipping address, and the like, stored in the payment service database 932 from at least one previous transaction conducted by the consumer 904 with any merchant associated with the payment service 902, such as the first transaction described above with respect to FIGS. 10, 11, and 12.

In one embodiment, the payment service 902 stores the credit card number associated with the consumer 904 from the first transaction in the database 932 and retrieves the credit card number along with the consumer information.

In another embodiment, the payment service 902 does not store credit card numbers retrieved from the information service 905 during the first transaction. In these embodiments, the payment service 902 requests the credit card number associated with the unique identifier from the information service 905. At event 1350a the payment service server 912 requests credit card information from the information service server 915. In an embodiment, the payment service server 912 requests the credit card number associated with the consumer 904. In another embodiment, the payment service server 914 sends the unique identifier with the request for the credit card information.

The information service server 915 receives the request for credit card information from the payment service server 912. The information service database 935 stores at least credit card information associated with the consumer 904. In another embodiment, the information service database 935 stores at least a credit card number associated with the consumer 904. At event 1352, the server 915 looks up the credit card information in the database 935.

At event 1350b, the information service server 915 sends to the payment service server 912 the credit card information associated with the consumer 904. In an embodiment, the information service server sends the credit card number associated with the consumer 904. In another embodiment, the information service server 915 sends at least one partial or masked credit card number associated with the consumer 904. For example, the information service server 915 sends more than one partial or masked credit card number associated with the consumer 904, such that the consumer 904 can choose which credit card to use for the payment. For example, a masked credit card number comprises the last four digits or some other subset of the digits of the credit card number and the remaining digits are masked.

In an embodiment, as indicated at event 1314, the payment service 102 provides an option for the consumer 904 to use the retrieved consumer information to make a payment to the merchant. In another embodiment, at event 1314, the payment service server 912 populates the payment page with the consumer information and the credit card information, which includes the credit card number. In yet another embodiment, the payment service server 912 serves the computing device 914 through the browser 924 a new page including the retrieved consumer information and the retrieved credit card information, which includes the credit card number.

If the consumer information is not found in the payment service database 932, the payment service server 912 sends an incomplete payment page to the consumer computing device 914 through the browser 924, as described below in FIG. 16. The consumer 904 populates the payment page with the consumer information and continues with the transaction.

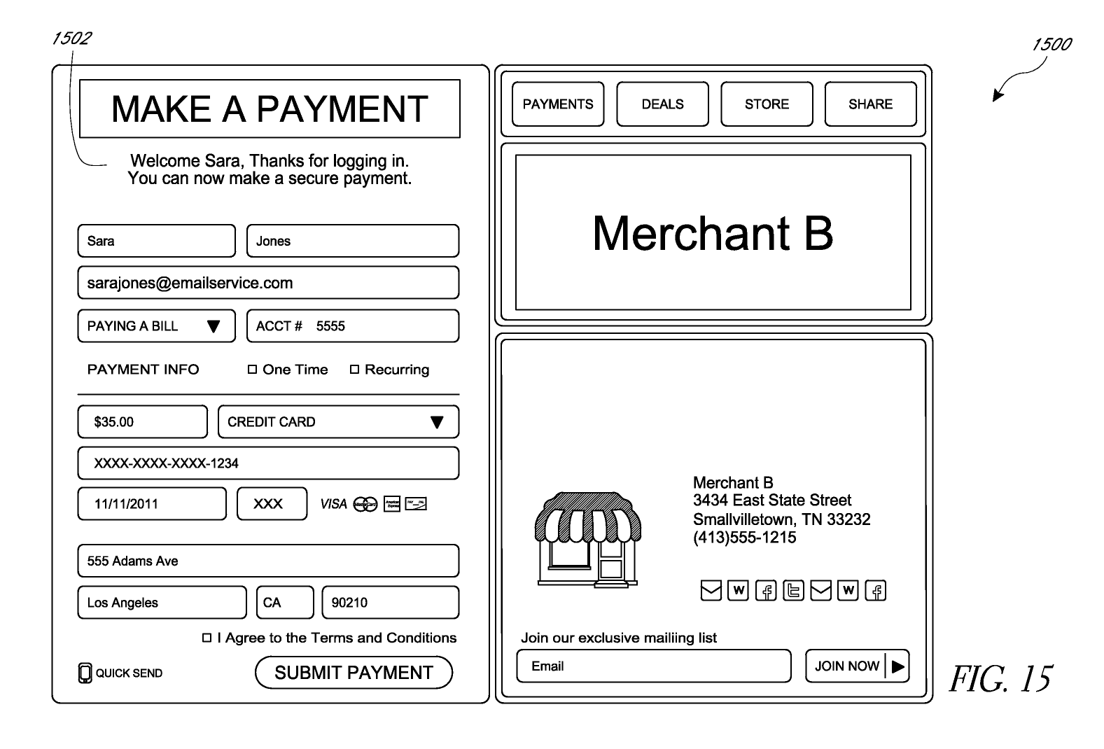

FIG. 15 illustrates an exemplary web page 1500 displayed to the consumer 904 after authentication of the second transaction. The payment page 1500 prompts the consumer 904 to verify the information. In one embodiment, payment page 1500 includes the consumer information retrieved from the payment service database 932 and the credit card information received from the information service database 935. The consumer 904 verifies the consumer information and the credit card information and enters the payment amount. In another embodiment, the server 912 supplies the consumer information and the credit card information, including the payment amount and the consumer 904 verifies the consumer information, the credit card information, and the payment amount.

In the illustrated example, the page 1500 is personalized with the following message 1502, which prompts the consumer 904 to verify the consumer information and the credit card information: “Welcome Sara, Thanks for logging in. You can now make a secure payment.”

The page 1500 comprises populated form entry fields for customer information, such as name and email address, type of activity, and payment information, such as the credit card number. In the illustrated embodiment, the server 912 populated the consumer's name, email address, type of activity (paying a recurring bill to account number 5555), the amount to be charged to the displayed credit card number, the expiration date, and the billing address of the card. In other embodiments, other information stored in the database 932 and associated with the unique identifier, such as for example, the shipping address, the name on the credit card, the contact phone number, Geo IP locations, purchasing habits, styles, all merchants that have been shopped, other payment options such as automated clearing house (ACH), gift cards, alternative payment options, and the like, could be populated on the payment page 1500.

At event 1316, the consumer 904 verifies the populated information. In an embodiment desired, the consumer can update the information provided on the payment page 1500. For example, if the consumer 904 has moved, the consumer 904 can revise the billing address associated with the credit card number. In an embodiment, when the database 935 associated with the information service 905 includes more than one credit card number or more than one masked credit card number associated with the unique identifier, the consumer 904 chooses which credit card to use for the transaction. Further, the consumer 904 can indicate a different credit card to use for the transaction. To continue with the transaction, the consumer 904 verifies or revises the information.

At event 1318, the consumer 904 submits the information and the computing device 914 sends the consumer and payment information to the payment service server 912.

The payment service server 912 receives the information. At event 1320 of FIG. 13, the payment service server 912 determines whether the submitted consumer information includes any new or revised information, such as, for example, a different billing address, a different shipping address, or the like, that is not stored in the payment service database 932. If there is new and/or revised consumer information, the payment service server 912 saves the consumer information and associates the consumer information with the unique identifier in the payment service database 932. In another embodiment, the payment service server 912 saves any new and/or revised credit card information. In yet another embodiment, the payment server 912 does not save any credit card information.

For embodiments where the information service server 915 sends one or more partial or masked credit card numbers in response to the previous request for the consumer's credit card number, the payment service server 912 repeats events 1350a and 1350b to acquire the complete credit card number. At event 1350a, the payment service server 912 requests the complete credit card number associated with the consumer's selection on the payment page from the information service server 915. At event 1350b, the payment service server 912 receives from the information service server 915 the complete credit card number for the consumer's selected credit card.

The process 1300 at event 1322 in FIG. 13 is the same as the process 1000 at event 1022 in FIG. 10. As described above with respect to event 1022 of FIG. 10, the payment service server 912 sends transaction information comprising the credit card information, the payment amount, and merchant information to the credit card fulfillment service server 918, as indicated at event 1322 of FIG. 13.

FIG. 16 is a flow chart illustrating a process 1600 through which the consumer 904 has the option of using retrieved consumer information from the payment service database 932 and received credit card information from the information service database 935 to make a payment to the merchant, according to an embodiment. The process 1600 may be implemented in software code executed by a physical server or other computing system.

At block 1602, the payment service server 912 receives a request for the payment page 1100, 1400 from the consumer computing device 914 through the browser 924. In another embodiment, the merchant server or a third-party entity receives the request for the payment page 1100, 1400.

At block 1604, the payment service server 912 sends the payment page 1100, 1400 to the computing device 914. In other embodiments, the payment page 1100, 1400 is sent from the merchant server or a third-party entity server. The payment page 1100, 1400 prompts the consumer 904 to log into an external authentication service site 926. The external authentication service 906 is distinct from the payment service 902. A computing system 916, 926, 936 operated by the authentication service 906 is distinct from the computing system 912, 922, 932 operated by the payment service 902. In an embodiment, the external authentication service 906 is an authentication service of the information service or credit service 905, or the like. In another embodiment, the external authentication service 906 is distinct from the information service or credit service 905, and comprises a social media site, a social networking site, a webmail provider, or the like.

At block 1606, the payment service server 912 determines whether the login was successful. In an embodiment, the authentication service server 916 receives the login credentials from the consumer computing device 914 through the browser 924 and validates the login credentials according to the established procedure of the authentication service 906. The authentication service server 916 sends a token or other login indicator to the payment service server 912 via the computing device 914 and browser 924. The token indicates whether the login was successful and a successful login authenticates the consumer 904. Further, for a successful login, the authentication service server 916 also sends at least one unique identifier associated with the consumer 904 to the payment service server 912 via the computing device 914 and browser 924.

When the login is successful, the process 1600 moves to block 1608, where the payment service server 912 receives the unique consumer identifier from the authentication service server 916.

At block 1650, the payment service server 912 requests credit card information associated with the unique identifier from the information service server 915. At block 1652, the payment service server 1612 receives credit card information including at least one credit card number associated with the unique identifier from the information service server 915. In some embodiments, the payment service server receives one or more partial or masked credit card numbers.

At block 1610, the payment service server 912 searches the payment service database 932 for consumer information associated with the unique identifier. At block 1612, the payment service server 912 determines whether consumer information associated with the unique identifier was found. If the payment service server 912 retrieves consumer information associated with the unique identifier from the database 932, the process 1600 moves to block 1614.

At block 1614, the payment service server 912 provides the consumer 904 through the consumer computing device 914 and browser 924 the option of using the retrieved consumer information and the received credit card information including the credit card number to make a payment to the merchant. In some embodiments, the consumer 904 receives more than one partial or masked credit card number and can select which credit card number to use for the payment. In an embodiment, the payment service server 912 populates the payment page 1200, 1500. In another embodiment, the payment service server 912 serves a new payment page including the retrieved consumer information and the received credit card information to the consumer 904 through the browser 924 to the computing device 914. The consumer 904 verifies the populated consumer and credit card information, revises the information as applicable, and submits the payment page.

At block 1618, the payment service server 912 receives the submitted information from the computing device 914. In embodiments where the submitted information comprises a partial or masked credit card number, the process repeats blocks 1650 and 1652 to request and receive, respectively, the complete credit card number associated with the consumer's selected partial credit card number.

At block 1620, the payment service server 912 determines whether the submitted information includes revised or new consumer information that was not previously stored in the payment service database 932. In an embodiment, the payment service server 912 does not store credit card numbers. In another embodiment, the payment service server 932 stores a portion of the credit card number, such as the last four digits. In another embodiment, the payment service server stores the credit card number.

If the submitted consumer information is the same as the consumer information retrieved from the database 932, the payment service server 912 at block 1628 sends transaction information including the consumer information and the payment information to the credit card fulfillment service server 916, where the transaction is completed. In an embodiment, the credit card fulfillment service server 916 interfaces with the credit card server to debit the payment amount from the credit card account and interfaces with the server of the merchant's financial institution to credit the payment amount to the merchant account to complete the transaction.

When the login is unsuccessful at block 1606, the process 1600 moves to block 1626, where the payment service server 912 receives an indication of the unsuccessful login from the authentication service server 916.

At block 1628, the payment service server 912 sends a message to the consumer computing device 914 through the browser 924 that the login was unsuccessful and in an embodiment, gives the consumer 904 the option of logging into another authentication site 906, whose login prompt is found on the payment page 1100, 1400. If the consumer 904 chooses to log into another authentication service 906, the process 1600 moves to block 1606, where the payment service server 912 determines whether the login was successful.

At block 1628, in another embodiment, the consumer 904 also has the option of filling in and submitting the consumer information and the credit card information requested on the payment page 1100, 1400 to continue the transaction. If the consumer 904 chooses to enter and submit the requested information, the process moves to block 1616.

When, at block 1612, the payment service server 912 cannot retrieve the consumer information from the payment service database 932, the process 1600 moves to block 1616.

At block 1616, the payment service server 912 serves an incomplete payment page to the consumer computing device 914 through the browser 924. The payment page may include the received credit card information but not the consumer information. The consumer 904 completes and submits the requested consumer information. The process 1600 moves to block 1618, where the payment service server 912 receives the consumer information from the computing device 914.

At block 1620, as indicated above, the payment service server 112 determines whether the submitted consumer information includes new or revised information. If the consumer information is different from the retrieved consumer information, the process 1600 moves to block 1622, where the payment service server 912 saves the new/revised consumer information in the payment service database 932 and associates the new/revised information with the unique identifier.

The process 1600 then moves to block 1624, where the payment service server 912 sends the consumer information and the credit card information as transaction information to the credit card fulfillment service server 916, where the transaction is completed as described above.

Depending on the embodiment, certain acts, events, or functions of any of the algorithms described herein can be performed in a different sequence, can be added, merged, or left out all together (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

All of the processes and steps described above as being implemented by the payment service may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various payment service functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method performed by a computer-implemented payment service to enable users to use authentication service account information to make payments to merchants, the method comprising:
hosting a payment page of a merchant that has an account with the payment service, said payment page providing functionality for users to make payments to the merchant, said payment page comprising fields for user entry and submission of authentication service account log-in credentials;
transmitting the payment page over a network to a user computing device in response to a request received from the user computing device;
receiving, from the user computing device, authentication service account log-in credentials of a user, said log-in credentials submitted by the user via the payment page;
sending a user authentication request over a network to an authentication service, said user authentication request comprising said log-in credentials of the user, said authentication service being distinct from the payment service;
receiving a response from the authentication service to the user authentication request, said response including a user identifier of the user, said user identifier being distinct from the log-in credentials of the user;
sending a request for credit card information of the user over the network to a credit service, said credit card information request comprising said user identifier;
receiving credit card information of the user from the credit service in response to the request for credit card information, said credit card information comprising at least a credit card number;
retrieving consumer information of the user from a database of the payment service based at least partly on the user identifier received from the authentication service, said consumer information obtained by the payment service based on a previous payment transaction conducted by the user, said consumer information excluding complete credit card numbers; and
providing an option for the user to use the retrieved consumer information and the received credit card number to make a payment to the merchant;
said method performed in its entirety by a computing system of the payment service.

2. The method of claim 1, wherein a computing system operated by said authentication service is distinct from a computing system operated by said payment service.

3. The method of claim 1, wherein said authentication service comprises an authentication service of a social media site.

4. The method of claim 1, wherein said credit service comprises said authentication service.

5. The method of claim 1, wherein said authentication service is an authentication service of the credit service, said log-in credentials are credit service log-in credentials, and said link is a link to the authentication service of at least one credit service site.

6. A method performed by a computer-implemented payment service to enable users to use authentication service account information to make payments to merchants, the method comprising:
receiving a user identifier of a user in response to a user authentication request sent over a network to an authentication service, the user authentication request associated with a payment page of a merchant that has an account with a payment service, said payment page providing functionality for users to make payments to the merchant, said payment page including a user prompt for prompting the user to log into the authentication service and a link to at least one authentication service site, said user authentication request comprising authentication service log-in credentials of the user, said user identifier received when said authentication service validates said authentication service log-in credentials;
receiving credit card information of the user from an information service in response to a request for credit card information of the user, said credit card information comprising at least a credit card number;
automatically retrieving consumer information of the user from a database of the payment service based at least partly on the user identifier received from the authentication service, said consumer information obtained by the payment service based on a previous payment transaction conducted by the user, said consumer information excluding complete credit card numbers; and
providing an option for the user to use the retrieved consumer information and the received credit card number to make a payment to the merchant;
said method performed in its entirety by a computing system of the payment service.

7. The method of claim 6, wherein a computing system operated by said authentication service is distinct from a computing system operated by said payment service.

8. The method of claim 6, wherein said user identifier is distinct from the authentication service log-in credentials of the user.

9. The method of claim 6, wherein said information service comprises said authentication service.

10. The method of claim 6, wherein said authentication service comprises a social media service.

11. The method of claim 6, wherein said authentication service is an authentication service of a social media site, said log-in credentials are social media site log-in credentials, and said link is a link to the authentication service of at least one social media site.

12. The method of claim 6, wherein said authentication service is an authentication service of the information service, said log-in credentials are information service log-in credentials, and said link is a link to the authentication service of at least one information service site.

13. The method of claim 6, further comprising:
hosting the payment page of the merchant that has the account with the payment service; and
transmitting the payment page over the network to a user computing device in response to a request received from the user computing device.

14. A payment service system of a payment service for enabling users to use authentication service account information to make payments to merchants, comprising:
a computer system comprising one or more computers, said computer system programmed with executable code modules to at least:
receive a user identifier of a user in response to a user authentication request sent over a network to an authentication service, the user authentication request associated with a payment page of a merchant that has an account with a payment service, said payment page providing functionality for users to make payments to the merchant, said payment page including a user prompt for prompting the user to log into the authentication service and a link to at least one authentication service site, said user authentication request comprising authentication service log-in credentials of the user, said user identifier received when said authentication service validates said authentication service log-in credentials;
receive credit card information of the user from a credit reporting service in response to a request for credit card information of the user, said credit card information comprising at least a credit card number;
automatically retrieve consumer information of the user from a database of the payment service based at least partly on the user identifier received from the authentication service, said consumer information obtained by the payment service based on a previous payment transaction conducted by the user, said consumer information excluding complete credit card numbers; and
provide an option for the user to use the retrieved consumer information and the received credit card number to make a payment to the merchant.

15. The payment service system of claim 14, wherein a computing system operated by said authentication service is distinct from a computing system operated by said payment service.

16. The payment service system of claim 14, wherein said user identifier is distinct from the authentication service log-in credentials of the user.

17. The payment service system of claim 14, wherein said credit reporting service comprises said authentication service.

18. The payment service system of claim 14, wherein said authentication service comprises a social media service.

19. The payment service system of claim 14, wherein said authentication service is an authentication service of a social media site, said log-in credentials are social media site log-in credentials, and said link is a link to the authentication service of at least one social media site.

20. The payment service system of claim 14, wherein said authentication service is an authentication service of the credit reporting service, said log-in credentials are credit reporting service log-in credentials, and said link is a link to the authentication service of at least one credit reporting site.
